(19) United States
(12) Patent Application Publication
(10) Pub. No.: US 2019/0233761 A1
(43) Pub. Date: Aug. 1, 2019

(54) SOLID CLEANING COMPOSITION

(71) Applicants: Ecolab USA Inc., Saint Paul, MN (US); BASF SE, Ludwigshafen am Rhein (DE)

(72) Inventors: Wendy Lo, Saint Paul, MN (US); Erik C. Olson, Saint Paul, MN (US); Jon D. Hansen, Saint Paul, MN (US); Katherine J. Molinaro, Saint Paul, MN (US); James S. Dailey, Grosse Ile, MI (US)

(21) Appl. No.: 16/259,596

(22) Filed: Jan. 28, 2019

Related U.S. Application Data
(60) Provisional application No. 62/622,300, filed on Jan. 26, 2018.

(51) Int. Cl. C11D 1/29; C11D 1/83; C11D 3/34

(52) U.S. Cl. CPC C11D 1/29; C11D 3/3409; C11D 1/83

(57) ABSTRACT

A solid cleaning composition includes a solidified surfactant blend. The solidified surfactant blend includes (1) at least one metal alkyl ether sulfate having the formula:

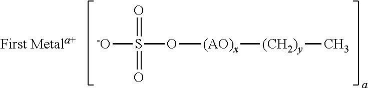

wherein the first metal is sodium, potassium, magnesium, or calcium, a is 1 or 2, AO is ethylene oxide, propylene oxide, or combinations thereof, x is 0.1 to 3, and y is 11 to 13. The solidified surfactant blend also includes a (2) solid surfactant and optionally (3) polyethylene glycol. Furthermore, (1) and (2) are present in a weight ratio of from 30:70 to 70:30 based on a total weight of the solidified surfactant blend. The solid cleaning composition has non-cohesive powder flow properties as determined using a Brookfield powder flow tester.

### CROSS-REFERENCE

This application claims priority under 35 U.S.C. § 119 to Provisional Application U.S. Ser. No. 62/622,300 filed Jan. 26, 2018, herein incorporated by reference in its entirety including without limitation, the specification, claims, and abstract, as well as any figures, tables, or examples thereof.

### FIELD OF THE DISCLOSURE

This disclosure generally relates to a solid cleaning composition. More specifically, this disclosure relates to a solid cleaning composition that includes a solidified surfactant blend comprising at least one metal alkyl ether sulfate and a solid surfactant.

### BACKGROUND

Some metal alkyl ether sulfate surfactants, such as sodium lauryl ether sulfate, are available only in liquid form. It is desirable to provide metal alkyl ether sulfate surfactants in solid form in order to make solid cleaning compositions. A challenge in formulating solid products is incorporating adequate amounts of liquid materials into the formulations without sacrificing the integrity or stability of the solid formulation.

Because some metal alkyl ether sulfate surfactants are only available in liquid form, they cannot easily be incorporated into solid formulations. This has limited the formulation of solid cleaning compositions. Accordingly, there remains opportunity for improvement

### SUMMARY OF THE DISCLOSURE

This disclosure provides a solid cleaning composition. The composition includes a solidified surfactant blend. The solidified surfactant blend includes (1) at least one metal alkyl ether sulfate having the formula:

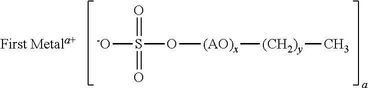

wherein the first metal is sodium, potassium, magnesium, or calcium, a is 1 or 2, AO is ethylene oxide, propylene oxide, or combinations thereof, x is from 0.1 to 3, and y is from 11 to 13. In a preferred embodiment, the solidified surfactant blend can also include (2) a solid surfactant and (3) a polyethylene glycol. In embodiments, the solidified surfactant blend further includes an alkalinity source. The at least one metal alkyl ether sulfate and solid surfactant are generally present in a weight ratio of from 30:70 to 70:30 based on a total weight of the solidified surfactant blend.

### DETAILED DESCRIPTION OF THE DISCLOSURE

This disclosure provides a solid cleaning composition. The composition can be used in any application in commercial, industrial, or household settings. The composition can be used in a variety of cleaning applications, including, but not limited to, in laundry, hard surface, ware wash, etc. The cleaning composition is “solid.”

The embodiments of this invention are not limited to particular cleaning applications, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

Certain terms are first defined so that this disclosure can be more readily understood. Unless defined otherwise, all technical and scientific terms used herein have the same meaning as commonly understood by one of ordinary skill in the art to which embodiments of the invention pertain. Many methods and materials similar, modified, or equivalent to those described herein can be used without undue experimentation, the preferred materials and methods are described herein. The following terminology will be used in accordance with the definitions set out below in the following description and the claims.

The term “about,” as used herein, refers to variation in the numerical quantity that can occur, for example, through typical measuring techniques and equipment, with respect to any quantifiable variable, including, but not limited to, mass, volume, and time. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

An “antiredeposition agent” refers to a compound that helps keep suspended in water instead of redepositing onto the object being cleaned. Antiredeposition agents are useful in the present invention to assist in reducing redepositing of the removed soil onto the surface being cleaned.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The methods and compositions of the present invention may comprise, consist essentially of, or consist of the components and ingredients of the present invention as well as other ingredients described herein. As used herein, “consisting essentially of” means that the methods, and compositions may include additional steps, components or ingredients, but only if the additional steps, components or ingredients do not materially alter the basic and novel characteristics of the claimed methods, and compositions.

The term “laundry” refers to items or articles that are cleaned in a laundry washing machine. In general, laundry refers to any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Exemplary treated fibers include those treated for flame retardancy. It should be understood that the term “linen” is often used to describe certain types of laundry items including bed sheets, pillow cases, towels, table linen, table cloth, bar mops and uniforms. The invention additionally provides a composition and method for treating non-laundry articles and surfaces including hard surfaces such as dishes, glasses, and other ware.

As used herein, the term “polymer” generally includes, but is not limited to, homopolymers, copolymers, such as for example, block, graft, random and alternating copolymers, terpolymers, and higher “x”mers, further including their derivatives, combinations, and blends thereof. Furthermore, unless otherwise specifically limited, the term “polymer” shall include all possible isomeric configurations of the monomers, including, but are not limited to isotactic, syndiotactic and random configurations, and combinations thereof. Furthermore, unless otherwise specifically limited, the term “polymer” shall include all possible geometrical configurations of the molecule.

As used herein, the term “solid” refers to a composition or material in a solid state. Solids can include powders, prills, beads or flakes. Powders can be prepared by grinding a larger solid composition, drying out a paste, or other methods of preparing a solid powder, including those described herein. Preferably, a powder needs to be flowable. Preferably, a solid powder has non-cohesive powder flow properties as determined using a Brookfield powder flow tester. In preferred embodiments, a solid powder has a flow function (ff) of less than about 0.4, more preferably less than about 0.35, most preferably between about 0.15 and about 0.35.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the invention include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers. Other exemplary plastics that can be cleaned using the compounds and compositions include polyethylene terephthalate (PET) polystyrene polyamide.

The terms “water soluble” and “water miscible” as used herein, means that the component (e.g., solid surfactant or metal alkyl ether sulfate) is soluble or dispersible in water at about 20° C. at a concentration greater than about 50 g/L, preferably at about 55 g/L or greater, more preferably at 60 g/L or greater, and most preferably at about 100 g/L or greater.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods, systems, apparatuses, and compositions may comprise, consist essentially of, or consist of the components and ingredients recited as well as other components and ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

### Solidified Surfactant Blend:

The composition includes a solidified surfactant blend. The solidified surfactant blend may be present in any amount, including and up to 100 weight percent of the composition. In various embodiments, the solidified surfactant blend is present in an amount of from 1 to 90 weight percent based on a total weight of the composition, e.g. ±5 wt %.

In various embodiments, the solidified surfactant blend is present in an amount of from 5 to 95, 1 to 75, 10 to 85, 15 to 80, 20 to 75, 25 to 70, 30 to 65, 35 to 60, 40 to 55, or 45 to 50, weight percent based on a total weight of a cleaning composition. In other embodiments, the solidified surfactant blend is present in an amount of 1, 2, 3, 4, or 5, weight percent based on a total weight of the composition.

The solidified surfactant blend includes (1) at least one metal alkyl ether sulfate and (2) a solid surfactant. In a preferred embodiment, the solidified surfactant blend includes (1) at least one metal alkyl ether sulfate, (2) a solid surfactant, and (3) a polyethylene glycol. In various embodiments, the solidified surfactant blend can include two or more (1) metal alkyl ether sulfates and/or two or more (2) solid surfactants. In various embodiments, the solidified surfactant blend is, consists essentially of, or consists of (1) and (2), or (1), (2), and (3). The combination of (1) and (2) may be alternatively described as an amorphous component (i.e., (1)) disposed in a crystalline matrix (i.e., (2)). In various embodiments, the composition is free of an alkyl polyglucoside (APG). In another embodiment, the composition is free of an amide, which may be any amide known in the art such as any used in a liquid or solid cleaning composition.

Typically, (1) and (2) are present in a weight ratio of from 20:80 to 70:30 based on a total weight of the solidified surfactant blend. In various embodiments, (1) is present such that the first value of the weight ratio is from 20 to 70, 25 to 65, 30 to 60, 35 to 55, 40 to 50, or 45 to 55. In other embodiments, (2) is present such that the second value of the weight ratio is from 30 to 80, 25 to 75, 40 to 70, 45 to 65, 50 to 60, or 55 to 60. In further embodiments, the weight ratio is 50:50 or 30:70±1, 2, 3, 4, 5, 6, 7, 8, 9, or 10. In various non-limiting embodiments, all values and ranges of values including and between those described above are hereby expressly contemplated for use herein.

### Metal Alkyl Ether Sulfate:

The (1) at least one metal alkyl ether sulfate has the formula:

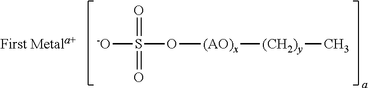

wherein the first metal is sodium, potassium, magnesium, or calcium, a is 1 or 2, AO is ethylene oxide, propylene oxide, or combinations thereof, x is 0.1 to 3, and y is 11 to 13. In various embodiments, the first metal is sodium. In other embodiments, the first metal is magnesium. In still further embodiments, the first metal is potassium or calcium. If the first metal is sodium or magnesium, a is 1. If the first metal is potassium or calcium, a is 2. In one embodiment, AO is ethylene oxide. In another embodiment, AO is propylene oxide. In a further embodiment, AO is a combination of ethylene oxide and propylene oxide. It is also contemplated that AO (and the solidified surfactant blend and/or composition as a whole) may be free of propylene oxide, butylene oxide, and/or any other oxides that are not ethylene oxide, and/or free of reaction products thereof. In further embodiments, x represents the degree of alkoxylation and is from 0.1 to 1, 0.2 to 0.9, 0.3 to 0.8, 0.4 to 0.7, 0.5 to 0.6, 1 to 3, 1 to 2, 2 to 3, 1.5 to 2.5, 2 to 2.5, or 1.5 to 3. In other embodiments, y represents a length of a carbon chain of the components and may be 11, 12, or 13. The (CH₂) moiety may be linear or branched. In various non-limiting embodiments, all values and ranges of values including and between those described above are hereby expressly contemplated for use herein.

### Solid Surfactant:

The solid surfactant may be any known in the art and may be crystalline or non-crystalline, and may be anionic, non-ionic, cationic, etc. For example, the solid surfactant may be chosen from Na LAS (sodium linear alkylbenzenesulfonate), sodium lauryl sulfoacetate, Sodium Alpha Olefin sulfonate (C14-16 AOS), disodium lauryl sulfosuccinate, sodium xylene sulfonate, sodium cumenesulfonate, and combinations thereof. In other embodiments, the solid surfactant is chosen from alcohol ethoxylates, EO-PO block copolymers, amides (lauryl diethanolamide, cocamide DEA, cocoamide MEA, cocamide mono isopropanolamine PEG 6 lauramide, and combinations thereof. All combinations of the aforementioned solid surfactants are also expressly contemplated in various non-limiting embodiments.

### Polyethylene Glycol

In a preferred embodiment, the solidified surfactant blend can comprise polyethylene glycol (PEG), a polyethylene glycol derivative, or combinations thereof. Preferably the PEG or PEG derivative has a weight average molecular weight of between about 1000 and 10,000, more preferably from about 1400 to about 10,000 g/mol, Preferred PEGs include PEG 1450, PEG 3350, PEG 4000, PEG 4600, and PEG 8000. Preferably the PEG is in an amount of between about 1 wt. % and about 20 wt. %, more preferably between about 5 wt. % and about 15 wt. % of the solidified surfactant blend.

### Metal Alkyl Sulfate:

The solid surfactant may be further defined as at least one (4) metal alkyl sulfate. The (4) at least one metal alkyl sulfate typically has the formula:

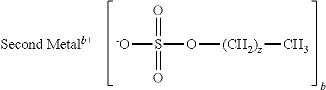

wherein the second metal is sodium, potassium, magnesium, or calcium, wherein b is 1 or 2, and wherein z is 11 to 13. In various embodiments, the second metal is sodium. In other embodiments, the second metal is magnesium. In still further embodiments, the second metal is potassium or calcium. If the second metal is sodium or magnesium, b is 1. If the second metal is potassium or calcium, b is 2. In further embodiments, z represents a length of a carbon chain of the components and may be 11, 12, or 13. The (CH₂) moiety may be linear or branched. In various non-limiting embodiments, all values and ranges of values including and between those described above are hereby expressly contemplated for use herein.

### Additional Surfactants:

As first introduced above, the solidified surfactant blend may further include, consist essentially of, or consist of, (5) a second metal alkyl ether sulfate component and/or (6) a second metal alkyl sulfate. These (5)/(6) second metal alkyl (ether) sulfates may be included in addition to (1), (2), and (3) above, in various embodiments.

The (5) second metal alkyl ether sulfate typically has the formula:

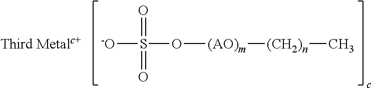

wherein the third metal is sodium, potassium, magnesium, or calcium, c is 1 or 2, AO is ethylene oxide, propylene oxide, or combinations thereof, m is 0.1 to 3, and n is 11 to 13. In various embodiments, the third metal is sodium. In other embodiments, the third metal is magnesium. In still further embodiments, the third metal is potassium or calcium. If the third metal is sodium or magnesium, c is 1. If the third metal is potassium or calcium, c is 2. In one embodiment, AO is ethylene oxide. In another embodiment, AO is propylene oxide. In a further embodiment, AO is a combination of ethylene oxide and propylene oxide. It is also contemplated that AO (and the solidified surfactant blend and/or composition as a whole) may be free of propylene oxide, butylene oxide, and/or any other oxides that are not ethylene oxide, and/or free of reaction products thereof. In further embodiments, m represents the degree of alkoxylation and is from 0.1 to 1, 0.2 to 0.9, 0.3 to 0.8, 0.4 to 0.7, 0.5 to 0.6, 1 to 3, 1 to 2, 2 to 3, 1.5 to 2.5, 2 to 2.5, or 1.5 to 3. In other embodiments, n represents a length of a carbon chain of the components and may be 11, 12, or 13. The (CH₂) moiety may be linear or branched. In various non-limiting embodiments, all values and ranges of values including and between those described above are hereby expressly contemplated for use herein.

In further embodiments, the (6) second metal alkyl sulfate typically has the formula:

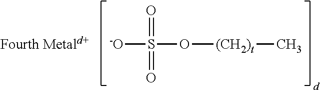

wherein the fourth metal is sodium, potassium, magnesium, or calcium, wherein d is 1 or 2, and wherein t is 11 to 13. In various embodiments, the fourth metal is sodium. In other embodiments, the fourth metal is magnesium. In still further embodiments, the fourth metal is potassium or calcium. If the fourth metal is sodium or magnesium, d is 1. If the fourth metal is potassium or calcium, d is 2. In further embodiments, t represents a length of a carbon chain of the components and may be 11, 12, or 13. The (CH₂) moiety may be linear or branched. In various non-limiting embodiments, all values and ranges of values including and between those described above are hereby expressly contemplated for use herein.

In various embodiments, 85 to 100 weight percent of the solidified surfactant blend is a combination of the (1) metal alkyl ether sulfate and the (2) solid surfactant, such as the (4) metal alkyl sulfate wherein each of y and z is 11. Moreover, 5 to 15 weight percent of the solidified surfactant blend may be a combination of the (4) second metal alkyl ether sulfate and the (5) second metal alkyl sulfate wherein each of n and t is 13. In other embodiments 90±1 weight percent of the solidified surfactant blend is a combination of the (1) metal alkyl ether sulfate and the (2) (or (5)) wherein each of y and z is 11. In addition, 10±1 weight percent of the solidified surfactant blend may be a combination of the (4) second metal alkyl ether sulfate and the (5) second metal alkyl sulfate wherein each of n and t is 13. In still other embodiments, 70 to 100 weight percent of the solidified surfactant blend is a combination of the (1) metal alkyl ether sulfate and the (4) metal alkyl sulfate wherein each of y and z is 11. Moreover, 25 to 35 weight percent of the solidified surfactant blend may be a combination of the (5) second metal alkyl ether sulfate and the (6) second metal alkyl sulfate wherein each of n and t is 13. In other embodiments, 70±1 weight percent of the solidified surfactant blend is a combination of the (1) metal alkyl ether sulfate and the (4) metal alkyl sulfate wherein each of y and z is 11. Furthermore, 30±1 weight percent of the solidified surfactant blend may be a combination of the (5) second metal alkyl ether sulfate and the (6) second metal alkyl sulfate wherein each of n and t is 13. In various non-limiting embodiments, all values and ranges of values including and between those described above are hereby expressly contemplated for use herein.

In still other embodiments, the solid cleaning composition includes less than 5, 4, 3, 2, 1, 0.5, or 0.1, weight percent of, or is free of, one or more of metal alkyl ether sulfates wherein y is 10 or less and/or wherein y is 14 or greater; metal alkyl sulfates wherein z is 10 or less and/or wherein z is 14 or greater; second metal alkyl ether sulfates wherein n is 10 or less and/or wherein n is 14 or greater; and/or second metal alkyl sulfates wherein t is 10 or less and/or wherein t is 14 or greater, or combinations thereof. Alternatively, the solid cleaning composition may include less than 5, 4, 3, 2, 1, 0.5, or 0.1, weight percent of, or be free of, one or more of metal alkyl ether sulfates wherein AO is propylene oxide; and/or second metal alkyl ether sulfates wherein AO is propylene oxide, or any one or more of the solid surfactants described above, or combinations thereof. In various non-limiting embodiments, all values and ranges of values including and between those described above are hereby expressly contemplated for use herein.

In additional embodiments, ((1) and optionally (5)) and ((4) and optionally (6)) are present in a weight ratio of from 70:30 to 50:50 of (1+4):(3+5), or in any one or more of the aforementioned weight ratios above. In other embodiments, ((1) and optionally (5)) and ((4) and optionally (6)) are present in a weight ratio of 70:30±5 of (1+4):(3+5), respectively, or in any one or more of the aforementioned weight ratios above.

### Alkalinity Source for Solidified Surfactant Blend

The solidified surfactant blend can comprise one or more alkalinity sources. It has been found that the alkalinity source can provide stability to the solidified surfactant blend, particularly at high temperatures.

Alkalinity sources can include, but are not limited to carbonate-based alkalinity sources, including, for example, carbonate salts such as alkali metal carbonates and bicarbonate; caustic-based alkalinity sources, including, for example, alkali metal hydroxides; other suitable alkalinity sources may include metal silicate, metal borate, and organic alkalinity sources. Exemplary alkali metal carbonates that can be used include, but are not limited to, sodium carbonate, potassium carbonate, bicarbonate, sesquicarbonate, and mixtures thereof. Exemplary alkali metal hydroxides that can be used include, but are not limited to sodium, lithium, or potassium hydroxide. Exemplary metal silicates that can be used include, but are not limited to, sodium or potassium silicate or metasilicate. Exemplary metal borates include, but are not limited to, sodium or potassium borate.

Organic alkalinity sources are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

When including an alkalinity source in the solidified surfactant blend, the alkalinity source is preferably added in an amount between about 0.1 wt. % and 15 wt. %, more preferably between about 1 wt. % and about 12 wt. %, most preferably between about 5 wt. % and about 10 wt. % of the solidified surfactant blend.

### Solid Cleaning Compositions

The solidified surfactant blend can be included in solid cleaning compositions. Those cleaning compositions can include, but are not limited to, detergent compositions, including, for example manual warewash compositions, laundry compositions, and hard surface cleaning compositions. Exemplary embodiments of those compositions are provided in Tables 1-3 below. In each of Tables 1-3, the surfactant component comprises the solidified surfactant blend. In some embodiments, the only surfactant added to the cleaning composition is the solidified surfactant blend. In some embodiments, the surfactant is a combination of the solidified surfactant blend and a co-surfactant. The compositions represented in Tables 1-3 are exemplary and not limiting, for example, other cleaning compositions can be prepared with the solidified surfactant blends described herein, and the cleaning compositions reflected below are offered as examples of preferred formulations.

TABLE 1
Exemplary Manual Warewash Composition

| | First | Second | Third |
|---|---|---|---|
| | Exemplary | Exemplary | Exemplary |
| Ingredient | Range (wt. %) | Range (wt. %) | Range (wt. %) |
| Alkalinity Source | 0-10 | 0-5 | 1-10 |
| Surfactant | 30-95 | 40-90 | 40-90 |
| Builders/Stabilizing | 0.1-40 | 0.1-30 | 0.1-40 |
| Agents | | | |
| Water | 0.01-20 | 0.1-10 | 0.01-10 |

TABLE 2
Exemplary Laundry Composition

| | First | Second | Third |
|---|---|---|---|
| | Exemplary | Exemplary | Exemplary |
| Ingredient | Range (wt. %) | Range (wt. %) | Range (wt. %) |
| Alkalinity Source | 30-90 | 40-80 | 50-70 |
| Surfactant | 0.01-40 | 0.1-35 | 1-30 |
| Builders/Stabilizing | 1-50 | 2-40 | 5-30 |
| Agents | | | |
| Water | 0-60 | 0.1-55 | 1-50 |

TABLE 3
Exemplary Hard Surface Cleaning Composition

| | First | | | Fourth |
|---|---|---|---|---|
| | Exemplary | Second | Third | Exemplary |
| | Range | Exemplary | Exemplary | Range |
| Ingredient | (wt. %) | Range (wt. %) | Range (wt. %) | (wt. %) |
| Surfactant | 1-20 | 1-10 | 30-95 | 30-95 |
| Builders/ | 0.01-30 | 0.1-40 | 0.1-40 | 0.1-40 |
| Stabilizing | | | | |
| Agents | | | | |
| Alkalinity | 30-90 | 40-90 | 20-50 | 0-10 |
| Source | | | | |
| Water | 0.01-20 | 0.1-10 | 0.01-10 | 0.01-10 |

### Additive Components

In addition to the solidified surfactant blend, the composition may also include an additive component. Additive components can be added to provide desired properties and functionalities to the compositions. Some particular examples of additive components are discussed in more detail below, although the particular materials discussed are given by way of example only, and that a broad variety of other additive components may be used. Examples of such additive components include chelating/sequestering agents; bleaching agents or activators; sanitizers/anti-microbial agents; activators; builder or fillers; anti-redeposition agents; optical brighteners; dyes; odorants or perfumes; preservatives; stabilizers; processing aids; corrosion inhibitors; fillers; solidifiers; hardening agent; solubility modifiers; pH adjusting agents; humectants; hydrotropes; color transfer inhibitors; foam inhibitors; complexing agents; enzymes; graying inhibitors; inorganic extenders; formulation auxiliaries; solubility improvers; opacifiers; electrolytes; soaps; detergents; soil release polymers; solvents; salts; water, or a broad variety of other additive components, depending upon the desired characteristics and/or functionality of the composition. In the context of some embodiments disclosed herein, the additive components are optionally included within the solid cleaning compositions for their functional properties. Some more particular examples of additive components are discussed in more detail below, but it should be understood by those of skill in the art and others that the particular materials discussed are given by way of example only, and that a broad variety of other additive components may be used.

Some of the additional ingredients described below can be included in the solid cleaning compositions comprised of a solidified surfactant blend. Preferred additional ingredients that can be incorporated into the cleaning compositions include, but are not limited to, a co-surfactant, dye, fragrance (odorant) coco monoethanolamide, a combination of lauryl/myristyl glucoside (and) sodium sulfate (and) sodium silicate (and) sodium coco sulfate, MgSO₄, sodium acetate, cocamidopropylamineoxide, cocamidopropyl betaine, laurylimino dipropionate mono sodium salt, lauryldimethylamine oxide, MA/DIB/Half ester with alcohol ethoxylated, and combinations thereof.

The additive component may be present in any amount along with the solidified surfactant blend. In various embodiments, the additive component is present in an amount of from 10 to 99 weight percent, e.g. ±5 wt %. In various embodiments, the additive component is present in an amount of from 10 to 95, 15 to 90, 20 to 85, 25 to 80, 30 to 75, 35 to 70, 40 to 65, 45 to 60, or 50 to 55, weight percent. In various non-limiting embodiments, all values and ranges of values including and between those described above are hereby expressly contemplated for use herein.

### Acid Source

In some embodiments, a cleaning composition can include an acid source. Suitable acid sources, can include, organic and/or inorganic acids. Examples of suitable organic acids include carboxylic acids such as but not limited to hydroxyacetic (glycolic) acid, citric acid, formic acid, acetic acid, propionic acid, butyric acid, valeric acid, caproic acid, trichloroacetic acid, urea hydrochloride, and benzoic acid, among others. Organic dicarboxylic acids such as oxalic acid, malonic acid, gluconic acid, itaconic acid, succinic acid, glutaric acid, maleic acid, fumaric acid, adipic acid, and terephthalic acid among others are also useful in accordance with the invention. Any combination of these organic acids may also be used intermixed or with other organic acids which allow adequate formation of the compositions.

Inorganic acids useful in accordance with the invention include sulfuric acid, sulfamic acid, methylsulfamic acid, hydrochloric acid, hydrobromic acid, and nitric acid among others. These acids may also be used in combination with other inorganic acids or with those organic acids mentioned above. In a preferred embodiment, the acid is an inorganic acid.

In some embodiments, the cleaning compositions provide a pH of at least about, preferably at least about 5.5, more preferably at least about 6, most preferably at least about 6.5. In some embodiments, the compositions provide a pH between about 6 and about 14, more preferably between about 6.5 and about 13, still more preferably between about 6.5 and about 12, most preferably between about 7 and about 11.5. In some embodiments, the acid source can be included as a pH modifier or neutralizer in a composition to achieve a desired pH.

### Activators

The composition may also include a bleach activator present in an amount of from 0.1 to 15% by weight. The bleach activator may include, but is not limited to, polyacylated sugars, e.g., pentaacetylglucose, acyloxybenzenesulfonic acids and alkali metal and alkaline earth metal salts thereof, e.g., sodium p-isononanoyloxybenzenesulfonate and sodium p-benzoyloxybenzenesulfonate, N,N-diacetylated and N,N,N′,N′-tetraacylated amines, e.g., N,N,N′,N′-tetraacetylmethylenediamine and -ethylenediamine (TAED), N,Ndiacetylaniline, N,N-diacetyl-p-toluidine or 1,3-diacylated hydantoins, such as 1,3-diacetyl-5,5-dimethylhydantoin, N-alkyl-N-sulfonylcarboxamides, e.g., N-methyl-N-mesylacetamide and N-methyl-N-mesylbenzamide, N-acylated cyclic hydrazides, acylated triazoles and urazoles, e.g., monoacetylmaleic acid hydrazide, O,N,N-trisubstituted hydroxylamines, e.g., O-benzoyl-N,N-succinylhydroxylamine, O-acetyl-N,N-succinylhydroxylamine and O, N,N-triacetylhydroxylamine, N,N′-diacylsulfurylamides, e.g., N,N′-dimethyl-N,N′-diacetylsulfurylamide and N,N′-diethyl-N,N′-dipropionylsulfurylamide, triacyl cyanurates, e.g., triacetyl cyanurate and tribenzoyl cyanurate, carboxylic anhydrides, e.g., benzoic acid anhydride, m-chlorobenzoic anhydride and phthalic anhydride, 1,3-diacyl-4,5-diacyloxyimidazolines, e.g., 1,3-diacetyl-4,5-diacetoxyimidazoline, tetraacetylglycoluril, tetrapropionylglycoluril, diacylated 2,5-diketopiperazines, e.g., 1,4-diacetyl-2,5-diketopiperazine, acylation products of propylenediurea and 2,2-dimethylpropylenediurea, e.g., tetraacetylpropylenediurea, a-acyloxypolyacylmalonamides, e.g., a-acetoxy-N,N′-diacetylmalonamide, diacyldioxohexahydro-1,3,5-triazines, e.g., 1,5-diacetyl-2,4-dioxohexahydro-1,3,5-triazine, benz(4H)-1,3-oxazin-4-ones with alkyl radicals, e.g., methyl, or aromatic radicals, and combinations thereof.

The bleach may also be combined with a bleach catalyst. The bleach catalyst may include, but is not limited to, quaternized imines, sulfonimines, manganese complexes, and combinations thereof. The bleach catalyst may be included in the composition in amounts up to 1.5% by weight.

In some embodiments, a cleaning composition can have improved the antimicrobial activity or bleaching activity by the addition of a material which, when the composition is placed in use, reacts with the active oxygen to form an activated component. For example, in some embodiments, a peracid or a peracid salt is formed. For example, in some embodiments, tetraacetylethylene diamine can be included within the composition to react with the active oxygen and form a peracid or a peracid salt that acts as an antimicrobial agent. Other examples of active oxygen activators include transition metals and their compounds, compounds that contain a carboxylic, nitrile, or ester moiety, or other such compounds known in the art. In an embodiment, the activator includes tetraacetylethylene diamine; transition metal; compound that includes carboxylic, nitrile, amine, or ester moiety; or mixtures thereof.

In some embodiments, an activator component can include in the range of up to about 75% by wt. of the cleaning composition, in some embodiments, in the range of about 0.01 to about 20% by wt., or in some embodiments, in the range of about 0.05 to 10% by wt. of the cleaning composition. In some embodiments, an activator for an active oxygen compound combines with the active oxygen to form an antimicrobial agent.

The activator can be coupled to solid cleaning compositions by any of a variety of methods for coupling one solid cleaning composition to another. For example, the activator can be in the form of a solid that is bound, affixed, glued or otherwise adhered to the solid cleaning composition. Alternatively, the solid activator can be formed around and encasing the solid cleaning composition. By way of further example, the solid activator can be coupled to the solid cleaning composition by the container or package for the composition, such as by a plastic or shrink wrap or film.

### Alkalinity Source for Cleaning Compositions

The cleaning compositions can include an effective amount of one or more alkalinity sources. An effective amount of one or more alkaline sources should be considered as an amount that provides a composition having a pH between about 7 and about 14. In a particular embodiment the cleaning compositions can have a pH of between about 7.5 and about 13.5. During a wash cycle the use solution can have a pH between about 6 and about 14. In particular embodiments, the use solution can have a pH between about 6 and 14. If the cleaning composition includes an enzyme composition, the pH may be modulated to provide the optimal pH range for the enzyme compositions effectiveness. In a particular embodiment incorporating an enzyme composition in the cleaning composition, the optimal pH is between about 10 and about 11.

Examples of suitable alkaline sources of the cleaning composition include, but are not limited to carbonate-based alkalinity sources, including, for example, carbonate salts such as alkali metal carbonates; caustic-based alkalinity sources, including, for example, alkali metal hydroxides; other suitable alkalinity sources may include metal silicate, metal borate, and organic alkalinity sources. Exemplary alkali metal carbonates that can be used include, but are not limited to, sodium carbonate, potassium carbonate, bicarbonate, sesquicarbonate, and mixtures thereof. Exemplary alkali metal hydroxides that can be used include, but are not limited to sodium, lithium, or potassium hydroxide. Exemplary metal silicates that can be used include, but are not limited to, sodium or potassium silicate or metasilicate. Exemplary metal borates include, but are not limited to, sodium or potassium borate.

Organic alkalinity sources are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

In general, alkalinity sources are commonly available in either aqueous or powdered form. Preferably, the alkalinity source is in a solid form. The alkalinity can be added to the composition in any form known in the art, including as solid beads, granulated or particulate form, dissolved in an aqueous solution, or a combination thereof.

In a preferred embodiments, the cleaning compositions include an alkalinity source in an amount between about 0.01% and about 99% by weight. In some embodiments, the alkalinity source will be between about 35% and about 95% by weight of the total weight of the cleaning composition. When diluted to a use solution, the compositions can include between about 5 ppm and about 25,000 ppm of an alkalinity source.

### Anti-Redeposition Agents

The cleaning compositions can optionally include an anti-redeposition agent capable of facilitating sustained suspension of soils in a cleaning or rinse solution and preventing removed soils from being redeposited onto the substrate being cleaned and/or rinsed. Some examples of suitable anti-redeposition agents can include fatty acid amides, fluorocarbon surfactants, complex phosphate esters, styrene maleic anhydride copolymers, and cellulosic derivatives such as hydroxyethyl cellulose, hydroxypropyl cellulose, and the like. A cleaning composition can include up to about 10 wt. %, and in some embodiments, in the range of about 1 to about 5 wt. %, of an anti-redeposition agent.

### Bleaching Agents

The cleaning compositions can optionally include bleaching agent. Bleaching agent can be used for lightening or whitening a substrate, and can include bleaching compounds capable of liberating an active halogen species, such as Cl₂, Br₂, —OCl⁻ and/or —OBr⁻, or the like, under conditions typically encountered during the cleansing process. Suitable bleaching agents for use can include, for example, chlorine-containing compounds such as a chlorine, a hypochlorite, chloramines, of the like. Some examples of halogen-releasing compounds include the alkali metal dichloroisocyanurates, chlorinated trisodium phosphate, the alkali metal hypochlorites, monochloramine and dichloroamine, and the like. Encapsulated chlorine sources may also be used to enhance the stability of the chlorine source in the composition (see, for example, U.S. Pat. Nos. 4,618,914 and 4,830,773, the disclosures of which are incorporated by reference herein). A bleaching agent may also include an agent containing or acting as a source of active oxygen. The active oxygen compound acts to provide a source of active oxygen, for example, may release active oxygen in aqueous solutions. An active oxygen compound can be inorganic or organic, or can be a mixture thereof. Some examples of active oxygen compound include peroxygen compounds, or peroxygen compound adducts. Some examples of active oxygen compounds or sources include hydrogen peroxide, perborates, sodium carbonate peroxyhydrate, phosphate peroxyhydrates, potassium permonosulfate, and sodium perborate mono and tetrahydrate, with and without activators such as tetraacetylethylene diamine, and the like.

Preferred bleaches may include, but is not limited to, alkali metal perborates, alkali metal carbonate perhydrates, peracids, hypochlorites, and combinations thereof. Suitable examples of peracids include, but are not limited to, peracetic acid, C₁-C₁₂ percarboxylic acids, C₈-C₁₆ dipercarboxylic acids, imidopercaproic acids, aryldipercaproic acids, linear and branched octane-, nonane-, decane- or dodecane-monoperacids, decane- and dodecane-diperacid, mono- and di-perphthalic acids, isophthalic acids and terephthalic acids, phthalimidopercaproic acid, terephthaloyldipercaproic acid, polymeric peracids, salts thereof, and combinations thereof.

A cleaning composition may include a minor but effective amount of a bleaching agent, for example, in some embodiments, in the range of between about 0.5 wt. % and about 30 wt. %.

### Builders

The cleaning compositions can comprise a builder. Preferred builders include organic builders. Additionally, the organic builder may include a polyaspartic acid or a co-condensate of aspartic acid with one or more amino acids including, but not limited to, C₄-C₂₅ mono- or di-carboxylic acids and/or C₄-C₂₅ mono- or di-amines. In one embodiment, the co-condensate includes a polyaspartic acid modified with C₆-C₂₂ mono- or dicarboxylic acids or with C₆-C₂₂ mono- or di-amines in acids including phosphorous.

Further, the organic builder may include a condensation product of citric acid and a hydroxycarboxylic acid or a polyhydroxy compound. Most typically, the condensation products of citric acid include carboxyl groups and have number average molecular weights of up to 10,000 g/mol. Still further, the organic builder may include ethylenediaminedisuccinic acid, oxydisuccinic acid, aminopolycarboxylates, aminopolyalkylene phosphonates, polyglutamates, and combinations thereof. Also, a non-limiting example of a suitable phosphonic acid includes hydroxyethanediphosphonic acid.

Alternatively, the organic builder may be selected from the group of olefins, ethers, esters, amines, oxidized starches, and combinations thereof. Suitable olefins, ethers, esters, and amines include, but are not limited to, monoethylenically unsaturated C₂-C₂₂ olefins, vinyl alkyl ethers with C₁-C₈ alkyl groups, styrene, vinyl esters of C₁-C₈ carboxylic acids, (meth)acrylamide and vinylpyrrolidone, (meth)acrylic esters of C₁-C₈ alcohols, (meth)acrylonitrile, (meth)acrylamides of C₁-C₈ amines, N-vinylformamide and vinylimidazole. In one embodiment, the organic builder is present in the composition in an amount of from 0.1 to 20% by weight.

### Carboxylic Acid Graft Polymers

Suitable examples of graft polymers of carboxylic acids include a graft base and an unsaturated carboxylic acid. The carboxylic acid may include, but is not limited to, maleic acid, fumaric acid, itaconic acid, citraconic acid, acrylic acid, methacrylic acid, crotonic acid, vinylacetic acid, and combinations thereof. Suitable graft bases included in the graft polymers of the carboxylic acids include degraded polysaccharides such as acidically and/or enzymatically degraded starches, inulins, cellulose, protein hydrolysates, reduced degraded polysaccharides such as mannitol, sorbitol, aminosorbitol and N-alkylglucamine, alkylene oxide block copolymers such as ethylene oxide/propylene oxide block copolymers, ethylene oxide/butylene oxide block copolymers, ethylene oxide/propylene oxide/butylene oxide block copolymers, and alkoxylated mono- or polyhydric C₁-C₇ alcohols and/or C₁₅-C₂₂ alcohols that are different from the first and second surfactants. It is to be understood that if alkoxylated mono- or polyhydric C₁-C₇ alcohols and/or C₁₅-C₂₂ alcohols are included in the composition, these alkoxylated alcohols are not equivalent to the first and second surfactants and may only be included in addition to the first and second surfactants. In one embodiment, 20 to 80 parts by weight of the carboxylic acid per 100 parts by weight of the graft base, may be polymerized. In this embodiment, a mixture of maleic acid and acrylic acid in the weight ratio from 90:10 to 10:90 is typically polymerized with the graft base.

### Chelating/Sequestering Agents

The cleaning compositions may also include effective amounts of chelating/sequestering agents, also referred to as builders. In addition, the cleaning compositions may optionally include one or more additional builders as a functional ingredient. In general, a chelating agent is a molecule capable of coordinating (i.e., binding) the metal ions commonly found in water sources to prevent the metal ions from interfering with the action of the other ingredients of a rinse aid or other cleaning composition. The chelating/sequestering agent may also function as a water conditioning agent when included in an effective amount. In some embodiments, a cleaning composition can include in the range of up to about 35 wt. %, or in the range of about 1-30 wt. %, of a chelating/sequestering agent.

Often, the cleaning composition is also phosphate-free and/or sulfate-free. In embodiments of the solid cleaning composition that are phosphate-free, the additional functional materials, including builders exclude phosphorous-containing compounds such as condensed phosphates and phosphonates.

Suitable additional builders include aminocarboxylates and polycarboxylates. Some examples of aminocarboxylates useful as chelating/sequestering agents, include, N-hydroxyethyliminodiacetic acid, nitrilotriacetic acid (NTA), ethylenediaminetetraacetic acid (EDTA), N-hydroxyethyl-ethylenediaminetriacetic acid (HEDTA) (in addition to the HEDTA used in the binder), diethylenetriaminepentaacetic acid (DTPA), methylglycine diacetic acid (MGDA), glutamic acid diacetic acid (GLDA), and the like. Some examples of polymeric polycarboxylates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

In embodiments of the solid cleaning composition which are not phosphate-free, added chelating/sequestering agents may include, for example a condensed phosphate, a phosphonate, and the like. Some examples of condensed phosphates include sodium and potassium orthophosphate, sodium and potassium pyrophosphate, sodium tripolyphosphate, sodium hexametaphosphate, and the like. A condensed phosphate may also assist, to a limited extent, in solidification of the composition by fixing the free water present in the composition as water of hydration.

In embodiments of the solid cleaning composition which are not phosphate-free, the composition may include a phosphonate such as 1-hydroxyethane-1,1-diphosphonic acid CH₃C(OH)[PO(OH)₂]₂; aminotri(methylenephosphonic acid) N[CH₂ PO(OH)₂]₃; aminotri(methylenephosphonate), sodium salt

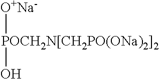

2-hydroxyethyliminobis(methylenephosphonic acid) HOCH₂ CH₂ N[CH₂ PO(OH)₂]₂; diethylenetriaminepenta(methylenephosphonic acid) (HO)₂ POCH₂ N[CH₂ N[CH₂ PO(OH)₂]₂]₂; diethylenetriaminepenta(methylenephosphonate), sodium salt C₉ H₍₂₈₋ₓ₎ N₃ NaₓO₁₅P₅ (x=7); hexamethylenediamine(tetramethylenephosphonate), potassium salt C₁₀ H₍₂₈₋ₓ₎N₂KₓO₁₂P₄ (x=6); bis(hexamethylene)triamine(pentamethylenephosphonic acid) (HO₂)POCH₂NRCH₂)₆N[CH₂ PO(OH)₂]₂]₂; and phosphorus acid H₃PO₃. In some embodiments, a phosphonate combination such as ATMP and DTPMP may be used. A neutralized or alkaline phosphonate, or a combination of the phosphonate with an alkali source prior to being added into the mixture such that there is little or no heat or gas generated by a neutralization reaction when the phosphonate is added can be used.

For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein.

### Color Transfer Inhibitors

Suitable color transfer inhibitors include, but are not limited to, color transfer inhibitors, for example homopolymers and copolymers of vinylpyrrolidone, of vinylimidazole, of vinyloxazolidone and of 4-vinylpyridine N-oxide having number average molecular weights of from 15,000 to 100,000 g/mol. In one embodiment, the composition includes the color transfer inhibitor present in an amount of from 0.05 to 5% by weight.

### Dicarboxylic Acid Copolymer

Examples of suitable copolymers of dicarboxylic acids include, but are not limited to, copolymers of maleic acid and acrylic acid in a weight ratio of 100:90 to 95:5 and more typically of 30:70 to 90:10 with molar masses from 100,000 to 150,000, and copolymers of maleic acid with C₂-C₈ olefins in a molar ratio 40:60 to 80:20. A non-limiting example of a suitable terpolymer of the carboxylic acids includes a terpolymer of maleic acid, acrylic acid and a vinyl ester of a C₁-C₃ carboxylic acid in a weight ratio of 10 (maleic acid):90 (acrylic acid+vinyl ester): 95 (maleic acid):10 (acrylic acid+vinyl ester), where the weight ratio of acrylic acid to the vinyl ester can be from 30:70 to 70:30.

### Dyes/Odorants

Various dyes, odorants including perfumes, and other aesthetic enhancing agents may also be included in the solid cleaning compositions. Dyes may be included to alter the appearance of the composition, as for example, FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

Fragrances or perfumes that may be included in the solid cleaning compositions include, for example, terpenoids such as citronellol, aldehydes such as amyl cinnamaldehyde, a jasmine such as C1S-jasmine or jasmal, vanillin, and the like.

### Enzymes and Enzyme Stabilizers

The cleaning compositions can optionally include an enzyme. Preferred enzymes include enzymes that provide desirable activity for removal of protein-based, carbohydrate-based, or triglyceride-based stains from a surface; for cleaning, destaining, and sanitizing presoaks, such as presoaks for medical and dental instruments, devices, and equipment; presoaks for flatware, cooking ware, and table ware; or presoaks for meat cutting equipment; for machine warewashing; for laundry and textile cleaning and destaining; for carpet cleaning and destaining; for cleaning-in-place and destaining-in-place; for cleaning and destaining food processing surfaces and equipment; for drain cleaning; presoaks for cleaning; and the like. Although not limiting to the present invention, enzymes suitable for the solid detergent compositions can act by degrading or altering one or more types of soil residues encountered on an instrument or device thus removing the soil or making the soil more removable by a surfactant or other component of the cleaning composition. Both degradation and alteration of soil residues can improve detergency by reducing the physicochemical forces that bind the soil to the instrument or device being cleaned, i.e., the soil becomes more water soluble. For example, one or more proteases can cleave complex, macromolecular protein structures present in soil residues into simpler short chain molecules which are, of themselves, more readily desorbed from surfaces, solubilized or otherwise more easily removed by detersive solutions containing said proteases.

Suitable enzymes include a protease, an amylase, a lipase, a gluconase, a cellulase, a peroxidase, a pectinase, a mannanase, or a mixture thereof of any suitable origin, such as vegetable, animal, bacterial, fungal or yeast origin. Preferred selections are influenced by factors such as pH-activity and/or stability optima, thermostability, and stability to active detergents, builders and the like. In this respect bacterial or fungal enzymes are preferred, such as bacterial amylases and proteases, and fungal cellulases. Preferably the enzyme is a protease, a lipase, an amylase, or a combination thereof.

“Detersive enzyme”, as used herein, means an enzyme having a cleaning, destaining or otherwise beneficial effect as a component of a solid detergent composition for instruments, devices, or equipment, such as medical or dental instruments, devices, or equipment; or for laundry, textiles, warewashing, cleaning-in-place, drains, carpets, meat cutting tools, hard surfaces, personal care, or the like.

Preferred detersive enzymes include a hydrolase such as a protease, an amylase, a lipase, or a combination thereof. Preferred enzymes in solid detergent compositions for cleaning medical or dental devices or instruments include a protease, an amylase, a cellulase, a lipase, or a combination thereof.

Preferred enzymes in solid detergent compositions for food processing surfaces and equipment include a protease, a lipase, an amylase, a gluconase, or a combination thereof.

Preferred enzymes in solid detergent compositions for laundry or textiles include a protease, a cellulase, a lipase, a peroxidase, or a combination thereof.

Preferred enzymes in solid detergent compositions for carpets include a protease, an amylase, or a combination thereof.

Preferred enzymes in solid detergent compositions for meat cutting tools include a protease, a lipase, or a combination thereof.

Preferred enzymes in solid detergent compositions for hard surfaces include a protease, a lipase, an amylase, or a combination thereof.

Preferred enzymes in solid detergent compositions for drains include a protease, a lipase, an amylase, or a combination thereof.

Preferred enzymes include those commercially available include, but are not limited to, the following: proteases such as Lavergy Pro, Savinase® and Esperase®, lipases such as Lipex®, cellulases such as Celluzym, and combinations thereof. Each of the Savinase®, Esperase®, Lipolase®, and Celluclean are commercially available from Novozymes of Franklinton, N.C.

Enzymes are normally incorporated into a solid detergent composition according to the invention in an amount sufficient to yield effective cleaning during a washing or presoaking procedure. An amount effective for cleaning refers to an amount that produces a clean, sanitary, and, preferably, corrosion free appearance to the material cleaned, particularly for medical or dental devices or instruments. An amount effective for cleaning also can refer to an amount that produces a cleaning, stain removal, soil removal, whitening, deodorizing, or freshness improving effect on substrates such as medical or dental devices or instruments and the like. Such a cleaning effect can be achieved with amounts of enzyme as low as about 0.1 wt-% of the solid detergent composition. In the cleaning compositions of the present invention, suitable cleaning can typically be achieved when an enzyme is present at about 0.5 to about 25 wt-%; preferably about 1 to about 15 wt-%; preferably about 1 to about 10 wt-%; preferably about 1 to about 8 wt-%. The higher enzyme levels are typically desirable in highly concentrated cleaning or presoak formulations. A presoak is preferably formulated for use upon a dilution of about 1:500, or to a formulation concentration of about 2000 to about 4000 ppm, which puts the use concentration of the enzyme at about 20 to about 40 ppm.

Commercial enzymes, such as alkaline proteases, are obtainable in liquid or dried form, are sold as raw aqueous solutions or in assorted purified, processed and compounded forms, and include about 2% to about 80% by weight active enzyme generally in combination with stabilizers, buffers, cofactors, impurities and inert vehicles. The actual active enzyme content depends upon the method of manufacture and is not critical; assuming the solid detergent composition has the desired enzymatic activity. The particular enzyme chosen for use in the process and products of this invention depends upon the conditions of final utility, including the physical product form, use pH, use temperature, and soil types to be degraded or altered. The enzyme can be chosen to provide optimum activity and stability for any given set of utility conditions.

The cleaning compositions of the present invention can include at least a protease for cleaning protein-containing soils. Further, enhanced protease activity can occur in the presence of one or more additional enzymes, such as amylase, cellulase, lipase, peroxidase, endoglucanase enzymes and mixtures thereof, preferably lipase or amylase enzymes.

A valuable reference on enzymes is “Industrial Enzymes”, Scott, D., in Kirk-Othmer Encyclopedia of Chemical Technology, 3rd Edition, (editors Grayson, M. and EcKroth, D.) Vol. 9, pp. 173 224, John Wiley & Sons, New York, 1980. When using enzymes, the methods of cleaning may also include the use of an enzyme stabilizing agent.

### Fillers

The solid cleaning compositions can optionally include a minor but effective amount of one or more of a filler. Some examples of suitable fillers may include sodium chloride, starch, sugars, C₁-C₁₀ alkylene glycols such as propylene glycol, sulfates, PEG, urea, sodium acetate, magnesium sulfate, sodium acetate, magnesium sulfate, sodium carbonate and the like. In some embodiments, a filler can be included in an amount in the range of up to about 50 wt. %, and in some embodiments, in the range of about 1-15 wt. %.

### Foam Inhibitors

Suitable foam inhibitors include, but are not limited to, organopolysiloxanes, silica, paraffins, waxes, microcrystalline waxes, and combinations thereof.

### Functional Polydimethylsiloxones

The solid cleaning composition can also optionally include one or more functional polydimethylsiloxones. For example, in some embodiments, a polyalkylene oxide-modified polydimethylsiloxane, nonionic surfactant or a polybetaine-modified polysiloxane amphoteric surfactant can be employed as an additive. Both, in some embodiments, are linear polysiloxane copolymers to which polyethers or polybetaines have been grafted through a hydrosilation reaction. Some examples of specific siloxane surfactants are known as SILWET® surfactants available from Union Carbide or ABIL® polyether or polybetaine polysiloxane copolymers available from Goldschmidt Chemical Corp., and described in U.S. Pat. No. 4,654,161 which patent is incorporated herein by reference. In some embodiments, the particular siloxanes used can be described as having, e.g., low surface tension, high wetting ability and excellent lubricity. For example, these surfactants are said to be among the few capable of wetting polytetrafluoroethylene surfaces. The siloxane surfactant employed as an additive can be used alone or in combination with a fluorochemical surfactant. In some embodiments, the fluorochemical surfactant employed as an additive optionally in combination with a silane, can be, for example, a nonionic fluorohydrocarbon, for example, fluorinated alkyl polyoxyethylene ethanols, fluorinated alkyl alkoxylate and fluorinated alkyl esters.

Further description of such functional polydimethylsiloxones and/or fluorochemical surfactants are described in U.S. Pat. Nos. 5,880,088; 5,880,089; and 5,603,776, all of which patents are incorporated herein by reference. We have found, for example, that the use of certain polysiloxane copolymers in a mixture with hydrocarbon surfactants provides excellent rinse aids on plastic ware. We have also found that the combination of certain silicone polysiloxane copolymers and fluorocarbon surfactants with conventional hydrocarbon surfactants also provide excellent rinse aids on plastic ware. This combination has been found to be better than the individual components except with certain polyalkylene oxide-modified polydimethylsiloxanes and polybetaine polysiloxane copolymers, where the effectiveness is about equivalent. Therefore, some embodiments encompass the polysiloxane copolymers alone and the combination with the fluorocarbon surfactant can involve polyether polysiloxanes, the nonionic siloxane surfactants. The amphoteric siloxane surfactants, the polybetaine polysiloxane copolymers may be employed alone as the additive in cleaning compositions to provide the same results.

In some embodiments, the composition may include functional polydimethylsiloxones in an amount in the range of up to about 10 wt. %. For example, some embodiments may include in the range of about 0.1 to 10 wt. % of a polyalkylene oxide-modified polydimethylsiloxane or a polybetaine-modified polysiloxane, optionally in combination with about 0.1 to 10 wt. % of a fluorinated hydrocarbon nonionic surfactant.

### Graying Inhibitors

Suitable graying inhibitors include, but are not limited to, polyesters of polyethylene oxides with ethylene glycol and/or propylene glycol and aromatic dicarboxylic acids or aromatic and aliphatic dicarboxylic acids, polyesters of polyethylene oxides terminally capped at one end with di- and/or polyhydric alcohols or dicarboxylic acids, polyethylene imines, polyethylene imine ethoxylates, and combinations thereof.

### Hardening/Solidification Agents/Solubility Modifiers

In some embodiments, one or more solidification agents may be included in the cleaning composition. Examples of hardening agents include urea, an amide such stearic monoethanolamide or lauric diethanolamide or an alkylamide, and the like; sulfate salts or sulfated surfactants, and aromatic sulfonates, and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the active ingredients may be dispensed from the solid composition over an extended period of time.

Suitable aromatic sulfonates include, but are not limited to, sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and/or sodium butyl naphthalene. Preferred aromatic sulfonates include sodium xylene sulfonate and sodium cumene sulfonate

The amount of solidification agent included in a cleaning composition can be dictated by the desired effect. In general, an effective amount of solidification agent is considered an amount that acts with or without other materials to solidify the cleaning composition. Typically, for solid embodiments, the amount of solidification agent in a cleaning composition is in a range of about 10 to about 80% by weight of the cleaning composition, preferably in the range of about 20 to about 75% by weight more preferably in the range of about 20 to about 70% by weight of the cleaning composition. The solidification agent is substantially free of sulfate. For example, the cleaning composition may have less than 1 wt. % sulfate, preferably less than 0.5 wt. %, more preferably less than 0.1 wt. %. In a preferred embodiment the cleaning composition is free of sulfate.

In certain embodiments it can be desirable to have a secondary solidification agent. In compositions containing secondary solidification the composition may include a secondary solidification agent in an amount in the range of up to about 50 wt. %. In some embodiments, secondary hardening agents are may be present in an amount in the range of about 5 to about 35 wt. %, often in the range of about 10 to about 25 wt. %, and sometimes in the range of about 5 to about 15 wt.-%.

In some embodiments, one or more additional hardening agents may be included in the solid cleaning composition if desired. Examples of hardening agents include an amide such stearic monoethanolamide or lauric diethanolamide, or an alkylamide, and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds may also vary the solubility of the composition in an aqueous medium during use such that the ingredients may be dispensed from the solid composition over an extended period of time. The composition may include a secondary hardening agent in an amount in the range of up to about 30 wt. %. In some embodiments, secondary hardening agents are may be present in an amount in the range of about 5 to about 25 wt. %, often in the range of about 10 to about 25 wt. %, and sometimes in the range of about 5 to about 15 wt. %.

### Humectant

The solid cleaning composition can also optionally include one or more humectants. A humectant is a substance having an affinity for water. The humectant can be provided in an amount sufficient to aid in reducing the visibility of a film on the substrate surface. The visibility of a film on substrate surface is a particular concern when the rinse water contains in excess of 200 ppm total dissolved solids. Accordingly, in some embodiments, the humectant is provided in an amount sufficient to reduce the visibility of a film on a substrate surface when the rinse water contains in excess of 200 ppm total dissolved solids compared to a rinse agent composition not containing the humectant. The terms “water solids filming” or “filming” refer to the presence of a visible, continuous layer of matter on a substrate surface that gives the appearance that the substrate surface is not clean.

Some example humectants that can be used include those materials that contain greater than 5 wt. % water (based on dry humectant) equilibrated at 50% relative humidity and room temperature. Exemplary humectants that can be used include glycerin, propylene glycol, sorbitol, alkyl polyglycosides, polybetaine polysiloxanes, and mixtures thereof. In some embodiments, the rinse agent composition can include humectant in an amount in the range of up to about 75% based on the total composition, and in some embodiments, in the range of about 5 wt. % to about 75 wt. % based on the weight of the composition.

### Hydratable Salt

The solid cleaning compositions according to the invention can optionally comprise at least one hydratable salt. In an embodiment the hydratable salt is sodium carbonate (aka soda ash or ash) and/or potassium carbonate (aka potash). In a preferred aspect, the hydratable salt is sodium carbonate and excludes potassium carbonate. The hydratable salt can be provided in the ranges from between approximately 20% and approximately 90% by weight, preferably between approximately 25% and approximately 90% by weight, and more preferably between approximately 30% and approximately 70% by weight hydratable salt, such as sodium carbonate. Those skilled in the art will appreciate other suitable component concentration ranges for obtaining comparable properties of the solidification matrix.

In other embodiments, the hydratable salt may be combined with other solidification agents. For example, the hydratable salt may be used with additional solidification agents that are inorganic in nature and may also act optionally as a source of alkalinity. In certain embodiments, the secondary solidification agent may include, but are not limited to: additional alkali metal hydroxides, anhydrous sodium carbonate, anhydrous sodium sulfate, anhydrous sodium acetate, and other known hydratable compounds or combinations thereof. According to a preferred embodiment, the secondary hydratable salt comprises sodium metasilicate and/or anhydrous sodium metasilicate. The amount of secondary solidifying agent necessary to achieve solidification depends upon several factors, including the exact solidifying agent employed, the amount of water in the composition, and the hydration capacity of the other cleaning composition components. In certain embodiments, the secondary solidifying agent may also serve as an additional alkaline source.

### Polymer

The cleaning compositions can include a polymer or a polymer system comprised of at least one polycarboxylic acid polymer, copolymer, and/or terpolymer. Particularly suitable polycarboxylic acid polymers, include, but are not limited to, polymaleic acid homopolymers, polyacrylic acid copolymers, and maleic anhydride/olefin copolymers.

Polymaleic acid (C₄H₂O₃)x or hydrolyzed polymaleic anhydride or cis-2-butenedioic acid homopolymer, has the structural formula:

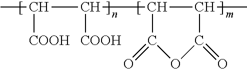

where n and m are any integer and wherein maleic acid moieties and maleic anhydride moieties may be arranged statistically or block-wise. Examples of polymaleic acid homopolymers, copolymers, and/or terpolymers (and salts thereof) which may be used for the invention are particularly preferred are those with a molecular weight of about 1000 and about 25,000, more preferably between about 1000 and about 5000. Commercially available polymaleic acid homopolymers include the Belclene 200 series of maleic acid homopolymers from BWA™ Water Additives, 979 Lakeside Parkway, Suite 925 Tucker, GA 30084, USA and Aquatreat AR-801 available from AkzoNobel. The polymaleic acid homopolymers, copolymers, and/or terpolymers may be present in cleaning compositions from about 0.01 wt. % to about 30 wt. %.

The cleaning compositions can use polyacrylic acid polymers, copolymers, and/or terpolymers. Poly acrylic acids have the following structural formula:

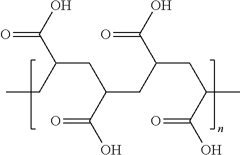

where n is any integer. Examples of suitable polyacrylic acid polymers, copolymers, and/or terpolymers, include but are not limited to, the polymers, copolymers, and/or terpolymers of polyacrylic acids, (C₃H₄O₂)ₙ or 2-Propenoic acid, acrylic acid, polyacrylic acid, propenoic acid.

In an embodiment, particularly suitable acrylic acid polymers, copolymers, and/or terpolymers have a molecular weight between about 100 and about 10,000, in a preferred embodiment between about 500 and about 7000, in an even more preferred embodiment between about 1000 and about 5000, and in a most preferred embodiment between about 1500 and about 3500. Examples of polyacrylic acid polymers, copolymers, and/or terpolymers (or salts thereof) which may be used for the invention include, but are not limited to, Acusol 448 and Acusol 425 from The Dow Chemical Company, Wilmington Del., USA. In particular embodiments it may be desirable to have acrylic acid polymers (and salts thereof) with molecular weights greater than about 10,000. Examples, include but are not limited to, Acusol 929 (10,000 MW) and Acumer 1510 (60,000 MW) both also available from Dow Chemical, AQUATREAT AR-6 (100,000 MW) from AkzoNobel Strawinskylaan 2555 1077 ZZ Amsterdam Postbus 75730 1070 AS Amsterdam. The polyacrylic acid polymer, copolymer, and/or terpolymer may be present in the compositions from about may be present in cleaning compositions from about 0.01 wt. % to about 30 wt. %.

Maleic anhydride/olefin copolymers are copolymers of polymaleic anhydrides and olefins. Maleic anhydride (C₂H₂(CO)₂O has the following structure:

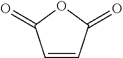

A part of the maleic anhydride can be replaced by maleimide, N-alkyl(C₁₋₄) maleimides, N-phenyl-maleimide, fumaric acid, itaconic acid, citraconic acid, aconitic acid, crotonic acid, cinnamic 10 acid, alkyl (C₁₋₁₈) esters of the foregoing acids, cycloalkyl(C₃₋₈) esters of the foregoing acids, sulfated castor oil, or the like.

At least 95 wt % of the maleic anhydride polymers, copolymers, or terpolymers have a number average molecular weight of in the range between about 700 and about 20,000, preferably between about 1000 and about 100,000.

A variety of linear and branched chain alpha-olefins can be used for the purposes of this invention. Particularly useful alpha-olefins are dienes containing 4 to 18 carbon atoms, such as butadiene, chloroprene, isoprene, and 2-methyl-1,5-hexadiene; 1-alkenes containing 4 to 8 carbon atoms, preferably C₄-10, such as isobutylene, 1-butene, 1-hexene, 1-octene, and the like.

In an embodiment, particularly suitable maleic anhydride/olefin copolymers have a molecular weight between about 1000 and about 50,000, in a preferred embodiment between about 5000 and about 20,000, and in a most preferred embodiment between about 7500 and about 12,500. Examples of maleic anhydride/olefin copolymers which may be used for the invention include, but are not limited to, Acusol 460N from The Dow Chemical Company, Wilmington Del., USA. The maleic anhydride/olefin copolymer may be present in cleaning compositions from about 0.01 wt. % to about 30 wt. %.

### Sanitizers/Anti-Microbial Agents

The cleaning compositions can optionally include a sanitizing agent. Sanitizing agents also known as antimicrobial agents are chemical compositions that can be used in a solid functional material to prevent microbial contamination and deterioration of material systems, surfaces, etc. Generally, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds.

It should also be understood that active oxygen compounds, such as those discussed above in the bleaching agents section, may also act as antimicrobial agents, and can even provide sanitizing activity. In fact, in some embodiments, the ability of the active oxygen compound to act as an antimicrobial agent reduces the need for additional antimicrobial agents within the composition. For example, percarbonate compositions have been demonstrated to provide excellent antimicrobial action. Nonetheless, some embodiments incorporate additional antimicrobial agents.

The given antimicrobial agent, depending on chemical composition and concentration, may simply limit further proliferation of numbers of the microbe or may destroy all or a portion of the microbial population. The terms “microbes” and “microorganisms” typically refer primarily to bacteria, virus, yeast, spores, and fungus microorganisms. In use, the antimicrobial agents are typically formed into a solid functional material that when diluted and dispensed, optionally, for example, using an aqueous stream forms an aqueous disinfectant or sanitizer composition that can be contacted with a variety of surfaces resulting in prevention of growth or the killing of a portion of the microbial population. A three-log reduction of the microbial population results in a sanitizer composition. The antimicrobial agent can be encapsulated, for example, to improve its stability.

Some examples of common antimicrobial agents include phenolic antimicrobials such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary antimicrobial agents such as benzalkonium chloride, didecyldimethyl ammonium chloride, choline diiodochloride, tetramethyl phosphonium tribromide. Other antimicrobial compositions such as hexahydro-1,3,5-tris(2-hydroxyethyl)-s-triazine, dithiocarbamates such as sodium dimethyldithiocarbamate, and a variety of other materials are known in the art for their antimicrobial properties.

In embodiments of the solid cleaning composition which are phosphate-free, and/or sulfate-free, and also include an anti-microbial agent, the anti-microbial is selected to meet those requirements. Embodiments of the solid cleaning composition which include only GRAS ingredients, may exclude or omit anti-microbial agents described in this section.

In some embodiments, the cleaning composition comprises, an antimicrobial component in the range of up to about 10% by wt. of the composition, in some embodiments in the range of up to about 5 wt. %, or in some embodiments, in the range of about 0.01 to about 3 wt. %, or in the range of 0.05 to 1% by wt. of the composition.

### Soil Release Polymers

Suitable soil release polymers include, but are not limited to, amphiphilic graft polymers or copolymers of vinyl esters and/or acrylic esters onto polyalkylene oxides or modified celluloses, such as methylcellulose, hydroxypropylcellulose, and carboxymethylcellulose, and combinations thereof. In one embodiment, the composition includes the soil release polymer present in an amount of from 0.3 to 1.5% by weight.

### Solvents

Various solvents can be incorporated into the solid cleaning compositions. Preferred solvents include, but are not limited to, ethylene glycol, 2-butoxyethanol, butyldiglycol, alkyl glycol ethers, and isopropanol.

### Additional Surfactants

The solidified surfactant blend and/or solid cleaning compositions can include optional co-surfactants. Preferably, a co-surfactant is in solid form. Further, the solidified surfactant blend and/or solid cleaning compositions can be incorporated in cleaning compositions. Those cleaning compositions can include, but are not limited to, detergent compositions, warewash compositions, laundry compositions, rinse aids, and hard surface cleaning compositions. Surfactants that can be included as a co-surfactant in the solidified surfactant blend and/or solid cleaning compositions, include, nonionic surfactants, semi polar nonionic surfactants, anionic surfactants, cationic surfactants, amphoteric surfactants, zwitterionic surfactants, and mixtures or combinations of the same.

When including a co-surfactant in the solidified surfactant blend and/or solid cleaning compositions, the co-surfactant is preferably present in amount of about 20 wt. % to about 90 wt. %, more preferably from about 30 wt. % to about 90 wt. %, and more preferably from about 40 wt. % to about 80 wt. %.

### Nonionic Surfactants

Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful nonionic surfactants include:

(1) Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-flinctional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

(2) Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

(3) Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co.

(4) Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade names Disponil manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances.

Examples of nonionic low foaming surfactants include:

(5) Compounds from (1) which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

(6) Compounds from groups (1), (2), (3) and (4) which are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

(7) The alkylphenoxypolyethoxyalkanols of U.S. Pat. No. 2,903,486 issued Sep. 8, 1959 to Brown et al. and represented by the formula

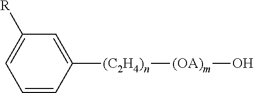

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ (C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ (C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ (C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

(8) Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

(9) The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

(10) The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

(11) Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

(12) Fatty acid amide surfactants suitable for use the present compositions include those having the formula: R₆CON(R7)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)xH, where x is in the range of from 1 to 3.

(13) A useful class of non-ionic surfactants include the class defined as alkoxylated amines or, most particularly, alcohol alkoxylated/aminated/alkoxylated surfactants. These non-ionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate. Preferred nonionic surfactants for the compositions include alcohol alkoxylates, EO/PO block copolymers, alkylphenol alkoxylates, and the like.

### Semi Polar Nonionic Surfactants

The semi-polar type of nonionic surface active agents are another class of nonionic surfactant useful in compositions. Generally, semi-polar nonionics are high foamers and foam stabilizers, which can limit their application in CIP systems. However, within compositional embodiments of this invention designed for high foam cleaning methodology, semi-polar nonionics would have immediate utility. The semi-polar nonionic surfactants include the amine oxides, phosphine oxides, sulfoxides and their alkoxylated derivatives.

Amine oxides are tertiary amine oxides corresponding to the general formula:

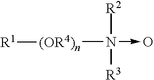

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Useful semi-polar nonionic surfactants also include the water soluble phosphine oxides having the following structure:

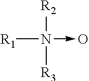

wherein the arrow is a conventional representation of a semi-polar bond; and, R¹ is an alkyl, alkenyl or hydroxyalkyl moiety ranging from 10 to about 24 carbon atoms in chain length; and, R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.

Semi-polar nonionic surfactants useful herein also include the water soluble sulfoxide compounds which have the structure:

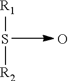

wherein the arrow is a conventional representation of a semi-polar bond; and, R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Nonionic surfactants suitable for use with the compositions include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

### Anionic Surfactants

Also useful in the compositions are surface active substances which are categorized as anionics because the charge on the hydrophobe is negative; or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility. As those skilled in the art understand, anionics are excellent detersive surfactants and are therefore favored additions to heavy duty detergent compositions.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Anionic sulfonate surfactants suitable for use in the present compositions also include alkyl sulfonates, the linear and branched primary and secondary alkyl sulfonates, and the aromatic sulfonates with or without substituents.

Anionic carboxylate surfactants suitable for use in the present compositions include carboxylic acids (and salts), such as alkanoic acids (and alkanoates), ester carboxylic acids (e.g. alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g. alkyl carboxyls). Secondary carboxylates useful in the present compositions include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a C₈ to C₂₂ alkyl group or

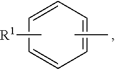

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₅-C₁₆ alkyl group. In some embodiments, R is a C₁₂-C₁₄ alkyl group, n is 4, and m is 1.

In other embodiments, R is

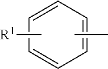

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include, Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g. the product Sandopan® DTC, a C₁₃ alkyl polyethoxy (7) carboxylic acid.

### Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g. alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic and/or more water dispersible, more easily water solubilized by co-surfactant mixtures, and/or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

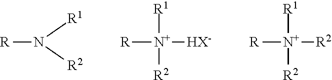

in which, R represents an alkyl chain, R′, R″, and R′″ may be either alkyl chains or aryl groups or hydrogen and X represents an anion. The amine salts and quaternary ammonium compounds are preferred for practical use in this invention due to their high degree of water solubility.

The majority of large volume commercial cationic surfactants can be subdivided into four major classes and additional sub-groups known to those or skill in the art and described in “Surfactant Encyclopedia”, Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

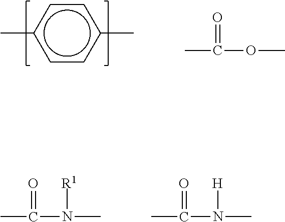

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens.

Y is can be a group including, but not limited to:

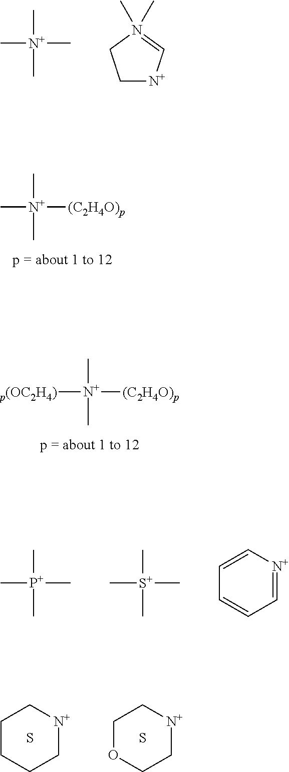

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water soluble anion, such as a halide, sulfate, methylsulfate, hydroxide, or nitrate anion, particularly preferred being chloride, bromide, iodide, sulfate or methyl sulfate anions, in a number to give electrical neutrality of the cationic component.

### Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives which can be used in the compositions generally have the general formula:

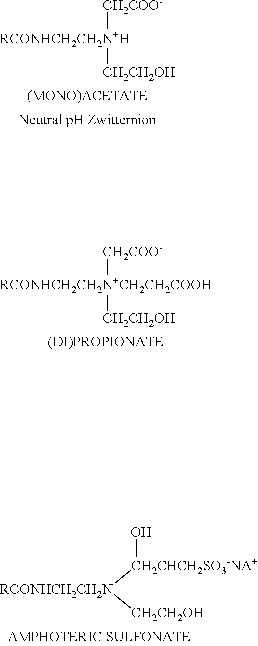

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this invention include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ from Solvay Novecare, Princeton, N.J. Another suitable coconut derived amphoteric surfactant with the chemical name disodium cocoampho diacetate is sold under the tradename Mirataine™, also from Solvay Novecare, Princeton, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated by reference in their entirety.

### Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

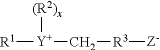

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylaonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-1N,N-di(2(2-hydroxyethyl)-N(2-hydroxydodecyl)ammoniol-butane-1-carboxylate; 3-1S-ethyl-S-(3-dodecoxy-2-hydroxypropyl)sulfoniol-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

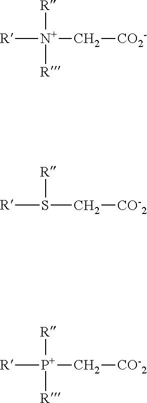

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines which may be useful in the compositions include those compounds having the formula (R(R¹)₂N⁺ R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated in their entirety.

### Method of Forming the Solidified Surfactant Blend:

This disclosure also provides a method of forming the cleaning composition. In one embodiment, the method includes the step of combining (1) and (3) and optionally (4) and/or (5), as described above. All combinations of (1)-(4) and all combinations of order of addition are hereby expressly contemplated.

In another embodiment, the method includes the steps of providing an alcohol having 12 to 14 carbon atoms, an alkylene oxide, and a sulfating component. Each of the aforementioned components can be combined in any order. The alcohol may be any known in the art that has 12, 13, or 14 carbon atoms. More than one alcohol or a mixture of alcohols can be utilized.

In various embodiments, the alcohol is further defined as 5, 10, 15, 20, 25, 30, 35, 40, 45, 50, 55, 60, 65, 70, 75, 80, 85, 90, or 95 weight percent of an alcohol having 8, 10, 12, 14, and/or 16 carbon atoms, each ±5 weight percent. In other words, any weight combination of C8-C16 alcohols may be utilized. In various embodiments, the alcohol is a combination of C12-C14 alcohols. The method may be free of, or exclude use of, alcohols having less than 12 or more than 14 carbons atoms. The alcohol(s) may be linear or branched and all isomers of alcohols having 8, 9, 10, 11, 12, 13, 14, 15, or 16 carbon atoms are hereby expressly contemplated for use. The alkylene oxide may be as described above and may be, for example, ethylene oxide, propylene oxide, or combinations thereof. The method may exclude use of propylene oxide. In one embodiment, the alkylene oxide is ethylene oxide and said step of alkoxylating is further defined as ethoxylating with 1 to 3 moles of ethylene oxide per 1 mole of the alcohol. The sulfating component may be any known in the including, but not limited to, SO₃ or any sulfating reagent.

The method also includes the step of alkoxylating the alcohol to form a combination of an ethoxylated alcohol and unreacted alcohol. The step of alkoxylating may be completed using any method known in the art. Typically, alkoxylation is completed at a temperature of from 100° C. to 160° C. and at a pressure of from 20 psig to 100 psig.

The method further includes the step of sulfating the ethoxylated alcohol and the unreacted alcohol to form (1) and (2) and optionally (3) and/or (4), as described above. The step of sulfating may be completed using any method known in the art.

### Additional Embodiments

In additional embodiments, this disclosure provides a method of forming a solid C12/C14-fatty alcohol+0.6EO-sulfate (Na) surfactant. For example, an alcohol ethoxylate can be produced by adding 0.6 mol of EO to a base catalyzed C₁₂₋₁₄ fatty alcohol and then sulfated. The sulfonation of the fatty alcohol ethoxylate can be done in a state of art falling film sulfonation reactor at a temperature of 40° C. with a molar ratio of SO3/alcohol ethoxylate of 1.0-1.05 with dry air/SO3 containing 5 vol % of SO3. The product can be neutralized after degassing with a mixture of caustic soda (50%) and water, calculated to obtain a concentration of approx. 30% active at a temperature of 65° C., keeping the pH-value in the range of 10-12 to avoid hydrolysis of the product. The resulting mixture can be dried by different procedures to obtain the solid surfactant. For example, the product may be dried by state of art freeze drying to obtain a product with a content of water <1%.

This disclosure also provides a method of forming solid blends of surfactants. For example, solid and liquid components can be mixed together until homogeneous. Water can then be removed from the solid in either a vacuum oven, in a conventional oven or by freeze drying. The materials can then be ground into a powder in a blade grinder.

### Methods of Manufacturing Cleaning Compositions

The solidified surfactant blend can be included in various cleaning compositions. Preferably, the cleaning compositions are solid compositions. Suitable solid cleaning compositions, include, but are not limited to granular and pelletized solid compositions, powders, solid block compositions, cast solid block compositions, extruded solid block composition, pressed solid compositions, and others. Preferably, the cleaning compositions are pressed solids.

Solid particulate cleaning compositions can be made by merely blending the dry solid ingredients in appropriate ratios or agglomerating the materials in appropriate agglomeration systems. Pelletized materials can be manufactured by compressing the solid granular or agglomerated materials in appropriate pelletizing equipment to result in appropriately sized pelletized materials. Solid block and cast solid block materials can be made by introducing into a container either a prehardened block of material or a castable liquid that hardens into a solid block within a container. Preferred containers include disposable plastic containers or water soluble film containers. Other suitable packaging for the composition includes flexible bags, packets, shrink wrap, and water soluble film such as polyvinyl alcohol.

The solid cleaning compositions may be formed using a batch or continuous mixing system. In an exemplary embodiment, a single- or twin-screw extruder is used to combine and mix one or more components at high shear to form a homogeneous mixture. In some embodiments, the processing temperature is at or below the melting temperature of the components. The processed mixture may be dispensed from the mixer by forming, casting or other suitable means, whereupon the cleaning composition hardens to a solid form. The structure of the matrix may be characterized according to its hardness, melting point, material distribution, crystal structure, and other like properties according to known methods in the art. Generally, a solid cleaning composition processed according to the method of the invention is substantially homogeneous with regard to the distribution of ingredients throughout its mass and is dimensionally stable.

In an extrusion process, the liquid and solid components are introduced into final mixing system and are continuously mixed until the components form a substantially homogeneous semi-solid mixture in which the components are distributed throughout its mass. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

In a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

In a pressed solid process, a flowable solid, such as granular solids or other particle solids are combined under pressure. In a pressed solid process, flowable solids of the compositions are placed into a form (e.g., a mold or container). The method can include gently pressing the flowable solid in the form to produce the solid cleaning composition. Pressure may be applied by a block machine or a turntable press, or the like. Pressure may be applied at about 1 to about 3000 psi, about 5 to about 2500 psi, or about 10 psi to about 2000 psi. As used herein, the term “psi” or “pounds per square inch” refers to the actual pressure applied to the flowable solid being pressed and does not refer to the gauge or hydraulic pressure measured at a point in the apparatus doing the pressing. The method can include a curing step to produce the solid cleaning composition. As referred to herein, an uncured composition including the flowable solid is compressed to provide sufficient surface contact between particles making up the flowable solid that the uncured composition will solidify into a stable solid cleaning composition. A sufficient quantity of particles (e.g. granules) in contact with one another provides binding of particles to one another effective for making a stable solid composition. Inclusion of an optional curing step may include allowing the pressed solid to solidify for a period of time, such as a few hours, or about 1 day (or longer). In additional aspects, the methods could include vibrating the flowable solid in the form or mold, such as the methods disclosed in U.S. Pat. No. 8,889,048, which is herein incorporated by reference in its entirety.

The use of pressed solids provides numerous benefits over conventional solid block or tablet compositions requiring high pressure in a tablet press, or casting requiring the melting of a composition consuming significant amounts of energy, and/or by extrusion requiring expensive equipment and advanced technical know-how. Pressed solids overcome such various limitations of other solid formulations for which there is a need for making solid cleaning compositions. Moreover, pressed solid compositions retain its shape under conditions in which the composition may be stored or handled.

By the term “solid”, it is meant that the hardened composition will not flow and will substantially retain its shape under moderate stress or pressure or mere gravity. A solid may be in various forms such as a powder, a flake, a granule, a pellet, a tablet, a lozenge, a puck, a briquette, a brick, a solid block, a unit dose, or another solid form known to those of skill in the art. The degree of hardness of the solid cast composition and/or a pressed solid composition may range from that of a fused solid product which is relatively dense and hard, for example, like concrete, to a consistency characterized as being a hardened paste. In addition, the term “solid” refers to the state of the cleaning composition under the expected conditions of storage and use of the solid cleaning composition. In general, it is expected that the cleaning composition will remain in solid form when exposed to temperatures of up to approximately 100° F. and particularly up to approximately 120° F.

The resulting solid cleaning composition may take forms including, but not limited to: a cast solid product; an extruded, molded or formed solid pellet, block, tablet, powder, granule, flake; pressed solid; or the formed solid can thereafter be ground or formed into a powder, granule, or flake. In an exemplary embodiment, extruded pellet materials formed by the solidification matrix have a weight of between approximately 50 grams and approximately 250 grams, extruded solids formed by the composition have a weight of approximately 100 grams or greater, and solid block detergents formed by the composition have a mass of between approximately 1 and approximately 10 kilograms. The solid compositions provide for a stabilized source of functional materials. In some embodiments, the solid composition may be dissolved, for example, in an aqueous or other medium, to create a concentrated and/or use solution. The solution may be directed to a storage reservoir for later use and/or dilution, or may be applied directly to a point of use.

The following patents disclose various combinations of solidification, binding and/or hardening agents that can be utilized in the solid cleaning compositions of the present invention. The following U.S. patents are incorporated herein by reference: U.S. Pat. Nos. 7,153,820; 7,094,746; 7,087,569; 7,037,886; 6,831,054; 6,730,653; 6,660,707; 6,653,266; 6,583,094; 6,410,495; 6,258,765; 6,177,392; 6,156,715; 5,858,299; 5,316,688; 5,234,615; 5,198,198; 5,078,301; 4,595,520; 4,680,134; RE32,763; and RE32818.

Use solutions can be prepared by dissolving and diluting the solid cleaning compositions. Use solutions have a concentration of active ingredients suitable for the desired cleaning application.

### Methods of Using the Cleaning Compositions

The cleaning compositions comprising the solidified surfactant blend can be used by contacting a surface with the cleaning compositions in dissolved form. The methods of use also encompass dispensing the cleaning compositions. Preferably, the cleaning compositions are dispensed in dissolved form. The cleaning compositions can be diluted as part of the dispensing, before dispensing, after dispensing, or a combination thereof. After dispensing, the cleaning composition can contact a surface. As described herein, surfaces can comprise a hard surface, ware, or laundry. Preferably, the cleaning compositions are in dissolved and diluted form. In some embodiments, the solid cleaning compositions can contact a surface and subsequently be dissolved on the surface with the addition of water. In some embodiments, the solid cleaning compositions can contact a surface in dissolved form and then be diluted while in contact with the surface. The methods can further comprise rinsing the surface with water before and/or after contact with the cleaning composition.

Preferably, the cleaning composition comprising the solidified surfactant blend provides substantially similar foam properties to a liquid cleaning composition having the same ingredients.

### Examples

Various embodiments of a solid cleaning composition are formed as set forth below along with various comparative compositions.

In various embodiments, the solidified surfactant blend includes a Sodium C₁₂₋₁₄ Ether Sulfate (SLES) which is (1) a metal alkyl ether sulfate having the formula:

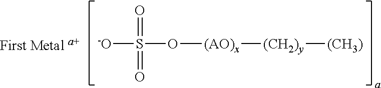

wherein the First Metal is Na, a is 1, AO is ethylene oxide, x is 1, and y is 11-13. It is known that this (1) metal alkyl ether sulfate includes a mixture of compounds wherein x is various values between 0.1 to 3 and y is various values between 11 and 13.

In various embodiments, the solidified surfactant blend includes Sodium C₁₂₋₁₄ (SLS) which is a (4) metal alkyl sulfate having the formula:

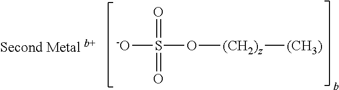

wherein the Second Metal is Na, b is 1 and z is 11-13. It is known that this (4) metal alkyl sulfate includes a mixture of compounds wherein z is various values between 11 and 13.

In further embodiments, the solidified surfactant blend includes a solid surfactant such as Sodium LAS which is sodium dodecylbenzenesulfonate. In further embodiments, various additives are also utilized, as set forth below.

Surfactant blend formulations were prepared according to Table 5A to determine if the blends would form solidified compositions. This is indicated in Table 5A with the description powder or paste. The descriptor “powder” indicates that the formulation formed a solid powder. The descriptor “paste” indicates that the formulation did not form into a solid. As can be seen in Table 5A the exemplary formulations 2-9 each formed powders. Formulation 1 did not form a powder, but was a paste.

TABLE 5A

| | 1 | 2 | 3 | 4 | 5 | 6 | 7 | 8 | 9 |
|---|---|---|---|---|---|---|---|---|---|
| Detergent Component | | | | | | | | | |
| Sodium C12-14 | 39.6% | 19.8% | 28.3% | 28.3% | 28.3% | 24.9% | 0.0% | 28.3% | 24.3% |
| Ether Sulfate | | | | | | | | | |
| Sodium C₁₂₋₁₄ alkyl | 60.4% | 80.2% | 51.7% | 44.7% | 44.7% | 58.1% | 0.0% | 21.7% | 55.7% |
| Sulfate | | | | | | | | | |
| Sodium LAS | | | | | | | 100.0% | 33.0% | 0.0% |
| Additive Component | | | | | | | | | |
| MgO₄ (anhydrous) | 0.0% | | 0.0% | 7.0% | | 7.0% | 0.0% | 7.0% | 3.0% |
| Na₂SO₄ (anhydrous) | | | | | 7.0% | | | | |
| Polyethylene Glycol | | | 20.0% | 20.0% | 20.0% | 10.0% | 0.0% | 10.0% | 10.0% |
| MW = 8000 | | | | | | | | | |
| Na₂CO₃ | | | | | | | | | 0.8% |
| N₂HCO₃ | | | | | | | | | 6.3% |
| Totals | 100.0% | 100.0% | 100.0% | 100.0% | 100.0% | 100.0% | 100.0% | 100.0% | 100.0% |
| % Anionic | 100.0% | 100.0% | 80.0% | 73.0% | 73.0% | 83.0% | 100.0% | 83.0% | 80.0% |
| Surfactant | | | | | | | | | |
| Physical Form after | Paste | powder | Powder | powder | powder | powder | powder | powder | powder |
| Drying | | | | | | | | | |

The SLES and the SLS are typically added as a mixture. In the compositions of Table 5A, an additional amount SLS and/or an additional amount of a different solid surfactant may also be added. The total weight percentages of the SLS, SLES, and solid surfactant are set forth below and are inclusive of all amounts present as a mixture plus all added amounts.

The surfactant blends that formed powders were evaluated to determine foam stability, as described in detail below, processability, and stability. These were tested against control formulations to assess the comparative properties. Control 1 was a powder sodium C12-14 sulfate. Control 2 was a paste-form sodium C12-14 ether sulfate. The results of this tested are provided below in Table 5B.

### Foam Stability Test Procedure:

40 ml of solutions of the surfactant blends (250 ppm active) were added to 250 ml graduated cylinders and placed in a rotating apparatus. The graduated cylinders are rotated at 30 rpm for 4 minutes. Initial foam height in ml in each graduated cylinder is recorded followed by addition of 2 drops (100 microliters via pipette) of corn oil. The graduated cylinders are then rotated for 2 minutes at 30 rpm and a new foam height is recorded. This procedure is repeated until the foam has disappeared as determined visually. The total number of drops of the oil needed to make the foam visually disappear is recorded as “Drops of Oil” in the Table 5B. Duplicate measurements were performed for all samples and the results set forth above represent an average of the two measurements.

Total Foam Volume is calculated as follows:

Total Foam Volume=Σ(Individual Foam Heights)−(Number of foam Heights)*40 mL

The compositions were also evaluated to determine the powder flow characteristics of the material. This was accomplished using a Brookfield Powder Flow tester. The sample compositions were placed in a cylindrical cell and compacted under a known stress. The normal stress acting on the column of the composition gradually increases until failure occurs and the peak normal stress is recorded. A plot of unconfined failure strength vs. the consolidated stress allows for a calculation of the flow function (ff). Lower flow function values are indicative of free flowing (non-cohesive) powder. It has been found that flow function of about 0.4 tends to be cohesive and nonflowable. It is possible that based on other conditions, e.g., internal friction and 1^{st} and 5^{th} consolidation strength, that some embodiments having a flow function (ff) of 0.4 can be flowable; however, typically this has not found to be the case. Accordingly, a flow function (ff) less than about 0.4 is indicative of a non-cohesive, free flowing powder. Preferably, the solidified surfactant blend has a flow function (ff) of less than about 0.4, more preferably less than about 0.35, most preferably between about 0.15 and about 0.35.

TABLE 5B

| | Control | Control | | | | | | | | | |
|---|---|---|---|---|---|---|---|---|---|---|---|
| | 1 | 2 | 1 | 2 | 3 | 4 | 5 | 6 | 7 | 8 | 9 |
| Physical Form after | powder | paste | paste | powder | Powder | powder | powder | powder | powder | powder | powder |
| Drying | | | | | | | | | | | |
| Foam Stability | | | | | | | | | | | |
| Drops of soil until | 9 | 52 | 86 | 24 | 56 | 38 | 30 | 44 | 8 | 45 | 54 |
| foam disappears | | | | | | | | | | | |
| Initial Foam Height | 250 | 250 | 250 | 175 | 250 | 250 | 250 | 250 | 250 | 250 | 250 |
| in ml | | | | | | | | | | | |
| Total Foam Volume | 450 | 2270 | 1575 | 450 | 2365 | 1320 | 1400 | 1800 | 305 | 2292 | 2292 |
| Flow Function (ff) | — | — | — | 0.43 | 0.19 | 0.50 | 0.20 | 0.20 | 0.25 | 0.26 | 0.25 |
| CAMSIZER | — | — | — | 0.654 | 0.71 | 0.682 | 0.72 | — | 0.54 | 0.71 | 0.76 |
| (sphericity) | | | | | | | | | | | |
| Stability? | — | — | — | — | n/a | n/a | n/a | No | n/a | n/a | Yes |
| Meet performance? | — | — | — | No | n/a | Yes | n/a | Yes | n/a | n/a | Yes |
| Process-able? | — | — | — | n/a | n/a | No | n/a | Yes | n/a | n/a | Yes |

Of the surfactant blend compositions that formed solid powders, it was found that formulations 6 and 9 had desired non-cohesive powder flow characteristics and were processable in a conventional setting. While not wishing to be bound by a particular theory, it is believed the addition of PEG improved flowability of the formed powders. Others compositions that formed powders, for example, composition 4, were found to be too cohesive and thus not flowable. While composition 6 was flowable, it was not thermally stable such that it could be processable in many larger scale commercial processes. It was found the addition of an alkalinity source to Formulation 9 improved the thermal stability of the formulation, such that it exhibited sufficient thermal stability for larger scale commercial processing.

All combinations of the aforementioned embodiments throughout the entire disclosure are hereby expressly contemplated in one or more non-limiting embodiments even if such a disclosure is not described verbatim in a single paragraph or section above. In other words, an expressly contemplated embodiment may include any one or more elements described above selected and combined from any portion of the disclosure. In various non-limiting embodiments, all values and ranges of values between and including the aforementioned values are hereby expressly contemplated.

One or more of the values described above may vary by ±5%, ±10%, ±15%, ±20%, ±25%, etc. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e. from 0.1 to 0.3, a middle third, i.e. from 0.4 to 0.6, and an upper third, i.e. from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

What is claimed is:

1. A solidified surfactant blend comprising;
(1) at least one metal alkyl ether sulfate having the formula: 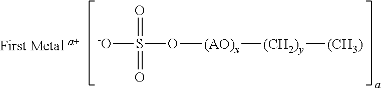
wherein First Metal is sodium, potassium, magnesium, or calcium, a is 1 or 2, AO is ethylene oxide, propylene oxide, or combinations thereof, x is 0.1 to 3, and y is 11 to 13, and
(2) a solid surfactant;
wherein (1) and (2) are present in a weight ratio of from about 30:70 to about 40:60 based on a total weight of said solidified surfactant blend; and
wherein said solidified surfactant blend has a flow function value of less than 0.4 as determined using a Brookfield powder flow tester.

2. The solidified surfactant blend of claim 1, further comprising (3) a polyethylene glycol.

3. The solidified surfactant blend of claim 1 wherein (2) is further defined as (4) at least one metal alkyl sulfate having the formula: 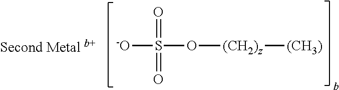
wherein Second Metal is sodium, potassium, magnesium, or calcium, wherein b is 1 or 2, and wherein z is 11 to 13.

4. The solidified surfactant blend of claim 1 further comprising an additive component, wherein (1) and (2) are present in an amount of from 25 to 85 weight percent based on a total weight of the solidified surfactant blend, wherein said polyethylene glycol is from about 1 to about 20 weight percent based on a total weight of the solidified surfactant blend, and said additive component is present in an amount of from about 15 to about 70 weight percent based on a total weight of the solidified surfactant blend.

5. The solidified surfactant blend of claim 3 wherein said first metal is sodium, a is 1, AO is ethylene oxide, said second metal is sodium, and b is 1.

6. The solidified surfactant blend of claim 5 wherein said metal alkyl ether sulfate is sodium lauryl ether sulfate and said metal alkyl sulfate is sodium lauryl sulfate.

7. The solidified surfactant blend of claim 6 wherein x is 1 to 3.

8. The solidified surfactant blend of claim 1 wherein said solidified surfactant blend further comprises:
(5) a second metal alkyl ether sulfate component having the formula: 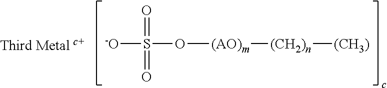
wherein Third Metal is sodium, potassium, magnesium, or calcium, c is 1 or 2, AO is ethylene oxide, propylene oxide, or combinations thereof, m is 0.1 to 3, and n is 11 to 13, and
(6) a second metal alkyl sulfate having the formula: 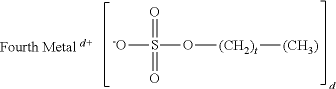
wherein Fourth Metal is sodium, potassium, magnesium, or calcium, wherein d is 1 or 2, and wherein t is 11 to 13.

9. The solidified surfactant blend of claim 8 wherein about 85 to about 95 weight percent of said solidified surfactant blend is a combination of said (1) metal alkyl ether sulfate and said (4) metal alkyl sulfate wherein each of y and z is 11, and
wherein about 5 to about 15 weight percent of said solidified surfactant blend is a combination of said (5) second metal alkyl ether sulfate and said (6) second metal alkyl sulfate wherein each of n and t is 13.

10. The solidified surfactant blend of claim 8 wherein about 65 to about 75 weight percent of said solidified surfactant blend is a combination of said (1) metal alkyl ether sulfate and said (4) metal alkyl sulfate wherein each of y and z is 11, and
wherein about 25 to about 35 weight percent of said solidified surfactant blend is a combination of said (5) second metal alkyl ether sulfate and said (6) second metal alkyl sulfate wherein each of n and t is 13.

11. The solidified surfactant blend of claim 8 that is free of:
(1) metal alkyl ether sulfates wherein y is 10 or less and/or wherein y is 14 or greater;
(4) metal alkyl sulfates wherein z is 10 or less and/or wherein z is 14 or greater;
(5) second metal alkyl ether sulfates wherein n is 10 or less and/or wherein n is 14 or greater; and
(6) second metal alkyl sulfates wherein t is 10 or less and/or wherein t is 14 or greater.

12. The solidified surfactant blend of claim 8 that is free of:
(1) metal alkyl ether sulfates wherein AO is propylene oxide; and
(5) second metal alkyl ether sulfates wherein AO is propylene oxide.

13. The solidified surfactant blend of claim 1 that is free of an alkyl polyglucoside (APG).

14. The solidified surfactant blend of claim 1 that is free of an amide.

15. The solidified surfactant blend of claim 8 wherein ((1) and optionally (5)) and ((4) and optionally (6)) are present in a weight ratio of from abut 30:70 to about 50:50, respectively.

16. The solidified surfactant blend of claim 8 wherein ((1) and optionally (5)) and ((4) and optionally (6)) are present in a weight ratio of 30:70±5, respectively.

17. The solidified surfactant blend of claim 1 wherein said solidified surfactant blend further comprises an alkalinity source in an amount between about 0.1 and about 15 weight percent based on a total weight of the solidified surfactant blend.

18. The solidified surfactant blend of claim 2 wherein the polyethylene glycol has a weight average molecular weight of about 8,000 g/mol.

19. The solidified surfactant blend of claim 1 wherein (2) is chosen from Na LAS (sodium linear alkylbenzenesulfonate), sodium lauryl sulfoacetate, Sodium Alpha Olefin sulfonate (C14-16 AOS), disodium lauryl sulfosuccinate, and combinations thereof.

20. The solidified surfactant blend of claim 1 wherein (2) is an alcohol ethoxylates or EO-PO block copolymer.

21. A method of forming the solidified surfactant blend of claim 1 comprising the step of combining the (1) and (2).

22. A method of forming the solidified surfactant blend of claim 3 comprising the steps of:
providing an alcohol having 12 to 14 carbon atoms, an alkylene oxide, and a sulfating component;
alkoxylating the alcohol to form a combination of an alkoxylated alcohol and unreacted alcohol;
sulfating the alkoxylated alcohol and the unreacted alcohol to form (1) and (4).

23. The method of forming the solidified surfactant blend of claim 22 wherein the alkylene oxide is ethylene oxide and said step of alkoxylating is further defined as ethoxylating with 0.4 to 3 moles of ethylene oxide per 1 mole of the alcohol.

24. The method of forming the solidified surfactant blend of claim 23 wherein the alcohol is further defined as 90 weight percent of C12 alcohol and 10 weight percent of C14 alcohol, each ±5 weight percent.

25. A solid cleaning composition comprising:
the solidified surfactant blend of claim 1.

26. The solid cleaning composition of claim 25, wherein the composition is a manual warewash composition, a laundry composition, a hard surface cleaning composition, or a combination thereof.

27. The solid cleaning composition of claim 26, wherein the solidified surfactant blend is present in an amount of between about 0.1 weight percent and about 95 weight percent of the solid cleaning composition.

28. The solid cleaning composition of claim 27, wherein the composition is a manual warewash composition further comprising an alkalinity source and a builder.

29. The solid cleaning composition of claim 28, wherein the alkalinity source is present in an amount between about 30 weight percent and about 90 weight percent of the solid cleaning composition.

30. The solid cleaning composition of claim 28, wherein the builder is in an amount between about 0.01 weight percent and about 30 weight percent of the solid cleaning composition.

31. The solid cleaning composition of claim 28, wherein the composition further comprises water in an amount between about 1 weight percent and about 50 weight percent of the solid cleaning composition.

32. The solid cleaning composition of claim 29, wherein the alkalinity source is present in an amount between about 30 weight percent and about 90 weight percent of the solid cleaning composition; wherein the builder is in an amount between about 0.01 weight percent and about 30 weight percent of the solid cleaning composition; wherein the solidified surfactant blend is in an amount between 0.01 weight percent and 50 weight percent of the solid cleaning composition; and wherein the composition further comprises water in an amount between about 1 weight percent and about 50 weight percent of the solid cleaning composition.

33. The solid cleaning composition of claim 26, wherein the composition is a laundry composition further comprising an alkalinity source and a builder.

34. The solid cleaning composition of claim 33, wherein the alkalinity source is present in an amount between about 30 weight percent and about 90 weight percent of the solid cleaning composition.

35. The solid cleaning composition of claim 33, wherein the builder is in an amount between about 0 weight percent and about 60 weight percent of the solid cleaning composition.

36. The solid cleaning composition of claim 33, wherein the composition further comprises water in an amount between about 1 weight percent and about 50 weight percent of the solid cleaning composition.

37. The solid cleaning composition of claim 33, wherein the alkalinity source is present in an amount between about 30 weight percent and about 90 weight percent of the solid cleaning composition; wherein the builder is in an amount between about 1 weight percent and about 50 weight percent of the solid cleaning composition; wherein the solidified surfactant blend is in an amount between 0.01 weight percent and 40 weight percent of the solid cleaning composition; and wherein the composition further comprises water in an amount between about 0 weight percent and about 60 weight percent of the solid cleaning composition.

38. The solid cleaning composition of claim 26, wherein the composition is a hard surface cleaning composition further comprising an alkalinity source and a builder.

39. The solid cleaning composition of claim 38, wherein the alkalinity source is present in an amount between about 30 weight percent and about 90 weight percent of the solid cleaning composition.

40. The solid cleaning composition of claim 38, wherein the builder is in an amount between about 0.01 weight percent and about 30 weight percent of the solid cleaning composition.

41. The solid cleaning composition of claim 38, wherein the composition further comprises water in an amount between about 0.01 weight percent and about 20 weight percent of the solid cleaning composition.

42. The solid cleaning composition of claim 38, wherein the alkalinity source is present in an amount between about 30 weight percent and about 90 weight percent of the solid cleaning composition; wherein the builder is in an amount between about 0.01 weight percent and about 30 weight percent of the solidified surfactant blend; wherein the solid detergent component is in an amount between 1 weight percent and 20 weight percent of the solid cleaning composition; and wherein the composition further comprises water in an amount between about 0.01 weight percent and about 20 weight percent of the solid cleaning composition.

43. The solid cleaning composition of claim 29, wherein the alkalinity source comprises an alkali metal hydroxide, an alkali metal carbonate, a metal silicate, a metal borate, an alkanol amine, or combinations thereof.

44. The solid cleaning composition of claim 43, wherein the alkalinity source is in an amount sufficient to provide a pH of between about 7 and about 14 in a use solution.

45. The solid cleaning composition of claim 26, wherein the solid cleaning composition provides pH of at least about 5.5.

46. The solid cleaning composition of claim 26 further comprising a cosurfactant comprising a nonionic surfactant, a cationic surfactant, an anionic surfactant, a semi-polar nonionic surfactant, an amphoteric surfactant, a zwitterionic surfactant, or a combination thereof.

47. The solid cleaning composition of claim 26, wherein the solid cleaning composition is a granular solid, pelletized solid, cast solid, extruded solid block, or pressed solid.

48. The solid cleaning composition of claim 47, wherein the cleaning composition is a pressed solid.

49. The solid cleaning composition of claim 26, further comprising at least one of the following additional ingredients an acid source, an activator, an anti-redeposition agent, a bleaching agent, a chelating agent, a dye, an odorant, a filler, a functional polydimethylsiloxone, a hardening agent, a hydratable salt, a polymer, or a sanitizer.

50. A method of cleaning a surface comprising:
contacting the surface with a cleaning composition of claim 25 in dissolved form.

51. The method of claim 50, wherein the cleaning composition is further in diluted form.

52. The method of claim 51, wherein the cleaning composition is diluted from the dissolved form.

53. The method of claim 50, wherein the surface comprises a hard surface, ware, or laundry.

54. The method of claim 53, further comprising rinsing the surface with water.

55. The method of claim 53, wherein the cleaning composition provides substantially similar foam properties to a cleaning composition having the same ingredients except that the metal alkyl ether sulfate is a liquid.

56. A method of dispensing a cleaning composition comprising:
dispensing the cleaning composition of claim 26 in dissolved form; and
contacting a surface with the cleaning composition.

57. The method of claim 56, wherein the cleaning composition is a powder, a flake, a granule, a pellet, a tablet, a lozenge, a puck, a briquette, a brick, a solid block, or a unit dose.

58. The method of claim 56, wherein the cleaning composition is diluted from the dissolved form.

59. The method of claim 56, wherein the surface comprises a hard surface, ware, or laundry.

60. The method of claim 59, further comprising rinsing the surface with water.

61. The method of claim 56, wherein the cleaning composition provides substantially similar foam properties to a cleaning composition having the same ingredients except that the metal alkyl ether sulfate is a liquid.
